(19) United States
(12) Patent Application Publication
(10) Pub. No.: US 2026/0181568 A1
(43) Pub. Date: Jun. 25, 2026

(54) UPLINK TIMING AND FREQUENCY ADJUSTMENT BASED ON ENERGY SAVING MODES

(71) Applicant: QUALCOMM Incorporated, San Diego, CA (US)

(72) Inventors: Navid ABEDINI, Basking Ridge, NJ (US); Tao LUO, San Diego, CA (US); Junyi LI, Greentown, PA (US); Xiaoxia ZHANG, San Diego, CA (US)

(21) Appl. No.: 19/429,893

(22) Filed: Dec. 22, 2025

Related U.S. Application Data
(60) Provisional application No. 63/738,386, filed on Dec. 23, 2024.

(51) Int. Cl. H04W 56/00; H04W 76/27

(52) U.S. Cl. CPC H04W 56/001; H04W 76/27

(57) ABSTRACT

Methods, systems, and devices for wireless communications are described. A user equipment (UE) may transmit, while operating in a second communication mode associated with a threshold for the first timing metric, a message to a network entity via first resources. Further, for the first resources, a first timing metric of the UE may fail to satisfy a threshold for operations via a first communication mode. The UE may then transmit, to the network entity, another message via second resources, where a type of message of the message is based on whether a second timing metric of the UE satisfies the threshold for the operations via the first communication mode for the second resources. Further, the network entity may switch communication modes and transmit a control message to the UE indication the switch. Moreover, the UE may further request for addition downlink reference signals which the network entity may transmit accordingly.

### CROSS REFERENCE

The present application for patent claims the benefit of U.S. Provisional Patent Application No. 63/738,386 by ABEDINI et al., entitled “UPLINK TIMING AND FREQUENCY ADJUSTMENT BASED ON ENERGY SAVING MODES,” filed Dec. 23, 2024, which is assigned to the assignee hereof, and is expressly incorporated by reference herein.

### FIELD OF TECHNOLOGY

The following relates to wireless communications, including uplink timing and frequency adjustment based on energy saving modes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, while operating in a second communication mode, a first uplink message to a network entity via first resources of an uplink data channel or an uplink control channel, where, for the first resources, a first timing metric of the UE fails to satisfy a first threshold for operations according to a first communication mode, and where the second communication mode is associated with a second threshold for the first timing metric and transmitting, to the network entity, a second uplink message via second resources, where a type of message of the second uplink message is based on whether a second timing metric of the UE satisfies the first threshold for the operations according to the first communication mode for the second resources.

A UE for wireless communications is described. The UE may include one or more memories storing processor executable code, and one or more processors coupled with the one or more memories. The one or more processors may individually or collectively be operable to execute the code to cause the UE to transmit, while operating in a second communication mode, a first uplink message to a network entity via first resources of an uplink data channel or an uplink control channel, where, for the first resources, a first timing metric of the UE fails to satisfy a first threshold for operations according to a first communication mode, and where the second communication mode is associated with a second threshold for the first timing metric and transmit, to the network entity, a second uplink message via second resources, where a type of message of the second uplink message is based on whether a second timing metric of the UE satisfies the first threshold for the operations according to the first communication mode for the second resources.

Another UE for wireless communications is described. The UE may include means for transmitting, while operating in a second communication mode, a first uplink message to a network entity via first resources of an uplink data channel or an uplink control channel, where, for the first resources, a first timing metric of the UE fails to satisfy a first threshold for operations according to a first communication mode, and where the second communication mode is associated with a second threshold for the first timing metric and means for transmitting, to the network entity, a second uplink message via second resources, where a type of message of the second uplink message is based on whether a second timing metric of the UE satisfies the first threshold for the operations according to the first communication mode for the second resources.

A non-transitory computer-readable medium storing code for wireless communications is described. The code may include instructions executable by one or more processors to transmit, while operating in a second communication mode, a first uplink message to a network entity via first resources of an uplink data channel or an uplink control channel, where, for the first resources, a first timing metric of the UE fails to satisfy a first threshold for operations according to a first communication mode, and where the second communication mode is associated with a second threshold for the first timing metric and transmit, to the network entity, a second uplink message via second resources, where a type of message of the second uplink message is based on whether a second timing metric of the UE satisfies the first threshold for the operations according to the first communication mode for the second resources.

Some examples of the method, UEs, and non-transitory computer-readable medium described herein may further include operations, features, means, or instructions for receiving, from the network entity, an indication of the first threshold associated with the first communication mode and the second threshold associated with the second communication mode.

Some examples of the method, UEs, and non-transitory computer-readable medium described herein may further include operations, features, means, or instructions for receiving, prior to transmitting the first uplink message, an indication of operation in the second communication mode, where the indication of operation in the second communication mode may be associated with a cell including the first resources and the second resources, a group of UEs, the UE, or any combination thereof.

In some examples of the method, UEs, and non-transitory computer-readable medium described herein, the indication of operation in the second communication mode may be received via one or more messages associated with a continuous-discontinuous reception (C-DRX) configuration, a cell discontinuous transmission (DTX) configuration, a cell discontinuous reception (DRX) configuration, or any combination thereof.

Some examples of the method, UEs, and non-transitory computer-readable medium described herein may further include operations, features, means, or instructions for transmitting, to the network entity, a request for operation in the second communication mode.

In some examples of the method, UEs, and non-transitory computer-readable medium described herein, the second communication mode may be associated with an inactive duration, an off duration, or both of a cell DTX configuration, a cell DRX configuration, a C-DRX configuration for the UE, or any combination thereof and the first communication mode may be associated with an active duration, an on duration, or both of the cell DTX configuration, the cell DRX configuration, the C-DRX configuration for the UE, or any combination thereof.

Some examples of the method, UEs, and non-transitory computer-readable medium described herein may further include operations, features, means, or instructions for selecting to operate within the second communication mode based on a duration of a cycle, an inactive period, or both of a discontinuous reception configuration, a discontinuous transmission configuration, or both, where transmission of the first uplink message may be based on selecting to operate within the second communication mode.

In some examples of the method, UEs, and non-transitory computer-readable medium described herein, the first uplink message may have a cyclic prefix of a first length based on the UE operating within the second communication mode, the first length being different from a second length that may be associated with the first communication mode.

In some examples of the method, UEs, and non-transitory computer-readable medium described herein, a first symbol of the first uplink message may be repeated as the cyclic prefix of a second symbol of the first uplink message based on the UE operating within the second communication mode.

Some examples of the method, UEs, and non-transitory computer-readable medium described herein may further include operations, features, means, or instructions for receiving, from the network entity, an indication of a reconfiguration of a slot structure for the first resources, the indication including the first length of the cyclic prefix for the first uplink message.

Some examples of the method, UEs, and non-transitory computer-readable medium described herein may further include operations, features, means, or instructions for receiving, from the network entity and in response to the first uplink message, an indication to adjust a timing of the UE, a frequency of the UE, or both based on the first timing metric of the UE failing to satisfy the first threshold for the operations according to the first communication mode.

In some examples of the method, UEs, and non-transitory computer-readable medium described herein, receiving the indication may include operations, features, means, or instructions for receiving, from the network entity, a timing adjustment command, a frequency adjustment command, or both.

In some examples of the method, UEs, and non-transitory computer-readable medium described herein, receiving the indication may include operations, features, means, or instructions for receiving, from the network entity, a downlink control information (DCI) message that includes the indication to adjust the timing of the UE, the frequency of the UE, or both and an indication of the second resources for the second uplink message.

In some examples of the method, UEs, and non-transitory computer-readable medium described herein, an offset between the DCI and the second uplink message may be based on reception of the indication via the DCI.

In some examples of the method, UEs, and non-transitory computer-readable medium described herein, the type of message of the second uplink message may be a first type of message associated with the first communication mode based on the second timing metric of the UE satisfying the first threshold for the operations according to the first communication mode for the second resources or may be a second type of message associated a reestablishment of the first communication mode based on the second timing metric of the UE failing to satisfy the first threshold for the operations according to the first communication mode for the second resources.

Some examples of the method, UEs, and non-transitory computer-readable medium described herein may further include operations, features, means, or instructions for determining that the second timing metric of the UE satisfies the first threshold for the operations according to the first communication mode for the second resources based on an absence of an indication for adjustment of the first timing metric, where the second uplink message may be associated with a first type of message based on the determination.

In some examples of the method, UEs, and non-transitory computer-readable medium described herein, transmitting the second uplink message may include operations, features, means, or instructions for transmitting, to the network entity, a request for an uplink timing advance command (TAC), a request for a frequency adjustment command, a request for one or more additional instances of a downlink reference signal, or any combination thereof.

In some examples of the method, UEs, and non-transitory computer-readable medium described herein, transmission of the request may be via a random access message, a scheduling request message, an uplink control channel message, an uplink data channel message, or any combination thereof.

Some examples of the method, UEs, and non-transitory computer-readable medium described herein may further include operations, features, means, or instructions for adjusting a duration of an uplink synchronization timer based on the UE operating within the second communication mode.

Some examples of the method, UEs, and non-transitory computer-readable medium described herein may further include operations, features, means, or instructions for performing one or more timing metric adjustments based on the first timing metric of the UE failing to satisfy the first threshold for the operations according to the first communication mode, where the one or more timing metric adjustments may be performed based on the first timing metric being within a respective range, the one or more timing metric adjustments may be performed based on a respective duration from expiration of a timer associated with the first communication mode, or both.

In some examples of the method, UEs, and non-transitory computer-readable medium described herein, the first uplink message, the second uplink message, or both include a request for an uplink TAC based on the first timing metric being outside of the respective range, an expiration of the respective duration, or both.

In some examples of the method, UEs, and non-transitory computer-readable medium described herein, the UE operates within the second communication mode based on a mobility metric of the UE.

A method for wireless communications by a network entity is described. The method may include switching from a first communication mode associated with a first set of timing conditions to a second communication mode associated with a second set of timing conditions, the first set of timing conditions including a first transmission periodicity for transmission of a downlink reference signal and the second set of timing conditions including a second transmission periodicity for the transmission of the downlink reference signal, where the second transmission periodicity is different from the first transmission periodicity, outputting, to a UE, a control message indicating that the network entity has switched to the second communication mode, the control message including an indication of the second set of timing conditions, obtaining, from the UE, a request for one or more additional instances of the downlink reference signal based on a satisfaction of one or more conditions, and outputting, to the UE, the one or more additional instances of the downlink reference signal based on reception of the request.

A network entity for wireless communications is described. The network entity may include one or more memories storing processor executable code, and one or more processors coupled with the one or more memories. The one or more processors may individually or collectively be operable to execute the code to cause the network entity to switch from a first communication mode associated with a first set of timing conditions to a second communication mode associated with a second set of timing conditions, the first set of timing conditions including a first transmission periodicity for transmission of a downlink reference signal and the second set of timing conditions including a second transmission periodicity for the transmission of the downlink reference signal, where the second transmission periodicity is different from the first transmission periodicity, output, to a UE, a control message indicating that the network entity has switched to the second communication mode, the control message including an indication of the second set of timing conditions, obtain, from the UE, a request for one or more additional instances of the downlink reference signal based on a satisfaction of one or more conditions, and output, to the UE, the one or more additional instances of the downlink reference signal based on reception of the request.

Another network entity for wireless communications is described. The network entity may include means for switching from a first communication mode associated with a first set of timing conditions to a second communication mode associated with a second set of timing conditions, the first set of timing conditions including a first transmission periodicity for transmission of a downlink reference signal and the second set of timing conditions including a second transmission periodicity for the transmission of the downlink reference signal, where the second transmission periodicity is different from the first transmission periodicity, means for outputting, to a UE, a control message indicating that the network entity has switched to the second communication mode, the control message including an indication of the second set of timing conditions, means for obtaining, from the UE, a request for one or more additional instances of the downlink reference signal based on a satisfaction of one or more conditions, and means for outputting, to the UE, the one or more additional instances of the downlink reference signal based on reception of the request.

A non-transitory computer-readable medium storing code for wireless communications is described. The code may include instructions executable by one or more processors to switch from a first communication mode associated with a first set of timing conditions to a second communication mode associated with a second set of timing conditions, the first set of timing conditions including a first transmission periodicity for transmission of a downlink reference signal and the second set of timing conditions including a second transmission periodicity for the transmission of the downlink reference signal, where the second transmission periodicity is different from the first transmission periodicity, output, to a UE, a control message indicating that the network entity has switched to the second communication mode, the control message including an indication of the second set of timing conditions, obtain, from the UE, a request for one or more additional instances of the downlink reference signal based on a satisfaction of one or more conditions, and output, to the UE, the one or more additional instances of the downlink reference signal based on reception of the request.

In some examples of the method, network entities, and non-transitory computer-readable medium described herein, the one or more conditions include a threshold time condition, a traffic priority condition, a level of mobility condition, a location condition, a beam change condition, a timing metric condition, or any combination thereof.

In some examples of the method, network entities, and non-transitory computer-readable medium described herein, satisfaction of the threshold time condition may be based on a time since a transmission of an adjustment command satisfying the threshold time condition.

In some examples of the method, network entities, and non-transitory computer-readable medium described herein, satisfaction of the traffic priority condition may be based on scheduling the UE with uplink traffic associated with a priority level that satisfies a traffic priority threshold.

In some examples of the method, network entities, and non-transitory computer-readable medium described herein, satisfaction of the level of mobility condition may be based on a level of mobility of the UE satisfying a threshold level of mobility.

In some examples of the method, network entities, and non-transitory computer-readable medium described herein, satisfaction of the location condition may be based on the UE moving a threshold distance away from the network entity.

In some examples of the method, network entities, and non-transitory computer-readable medium described herein, satisfaction of the beam change condition may be based on a change of a beam used by the UE.

In some examples of the method, network entities, and non-transitory computer-readable medium described herein, satisfaction of the timing metric condition may be based on the UE failing to satisfy a threshold for operations according to the first communication mode.

In some examples of the method, network entities, and non-transitory computer-readable medium described herein, the timing metric condition may be associated with a respective carrier frequency of the network entity, a cell associated with the downlink reference signal, a beam associated with the downlink reference signal, or a combination thereof.

A method for wireless communications by a network entity is described. The method may include obtaining, while a UE is operating in a second communication mode, a first uplink message from the UE via first resources of an uplink data channel or an uplink control channel, where, for the first resources, a first timing metric of the UE fails to satisfy a first threshold for operations according to a first communication mode, and where the second communication mode is associated with a second threshold for the first timing metric and obtaining, from the UE, a second uplink message via second resources, where a type of message of the second uplink message is based on whether a second timing metric of the UE satisfies the first threshold for the operations according to the first communication mode for the second resources.

A network entity for wireless communications is described. The network entity may include one or more memories storing processor executable code, and one or more processors coupled with the one or more memories. The one or more processors may individually or collectively be operable to execute the code to cause the network entity to obtain, while a UE is operating in a second communication mode, a first uplink message from the UE via first resources of an uplink data channel or an uplink control channel, where, for the first resources, a first timing metric of the UE fails to satisfy a first threshold for operations according to a first communication mode, and where the second communication mode is associated with a second threshold for the first timing metric and obtain, from the UE, a second uplink message via second resources, where a type of message of the second uplink message is based on whether a second timing metric of the UE satisfies the first threshold for the operations according to the first communication mode for the second resources.

Another network entity for wireless communications is described. The network entity may include means for obtaining, while a UE is operating in a second communication mode, a first uplink message from the UE via first resources of an uplink data channel or an uplink control channel, where, for the first resources, a first timing metric of the UE fails to satisfy a first threshold for operations according to a first communication mode, and where the second communication mode is associated with a second threshold for the first timing metric and means for obtaining, from the UE, a second uplink message via second resources, where a type of message of the second uplink message is based on whether a second timing metric of the UE satisfies the first threshold for the operations according to the first communication mode for the second resources.

A non-transitory computer-readable medium storing code for wireless communications is described. The code may include instructions executable by one or more processors to obtain, while a UE is operating in a second communication mode, a first uplink message from the UE via first resources of an uplink data channel or an uplink control channel, where, for the first resources, a first timing metric of the UE fails to satisfy a first threshold for operations according to a first communication mode, and where the second communication mode is associated with a second threshold for the first timing metric and obtain, from the UE, a second uplink message via second resources, where a type of message of the second uplink message is based on whether a second timing metric of the UE satisfies the first threshold for the operations according to the first communication mode for the second resources.

Some examples of the method, network entities, and non-transitory computer-readable medium described herein may further include operations, features, means, or instructions for outputting, to the UE, an indication of the first threshold associated with the first communication mode and the second threshold associated with the second communication mode.

Some examples of the method, network entities, and non-transitory computer-readable medium described herein may further include operations, features, means, or instructions for outputting, to the UE prior to receiving the first uplink message, an indication of operation in the second communication mode, where the indication of the second communication mode may be associated with a cell including the first resources and the second resources, a group of UEs, the UE, or any combination thereof.

In some examples of the method, network entities, and non-transitory computer-readable medium described herein, the indication of operation in the second communication mode may be received via one or more messages associated with a C-DRX configuration, a cell DTX configuration, a cell DRX configuration, or any combination thereof.

Some examples of the method, network entities, and non-transitory computer-readable medium described herein may further include operations, features, means, or instructions for obtaining, from the UE, a request for operation in the second communication mode.

In some examples of the method, network entities, and non-transitory computer-readable medium described herein, the second communication mode may be associated with an inactive duration, an off duration, or both of a cell DTX configuration, a cell DRX configuration, a C-DRX configuration for the UE, or any combination thereof and the first communication mode may be associated with an active duration, an on duration, or both of the cell discontinuous transmission configuration, the cell discontinuous reception configuration, the C-DRX configuration for the UE, or any combination thereof.

In some examples of the method, network entities, and non-transitory computer-readable medium described herein, the first uplink message may have a cyclic prefix of a first length based on the UE operating within the second communication mode, the first length being different from a second length that may be associated with the first communication mode.

In some examples of the method, network entities, and non-transitory computer-readable medium described herein, a first symbol of the first uplink message may be repeated as the cyclic prefix of a second symbol of the first uplink message based on the UE operating within the second communication mode.

Some examples of the method, network entities, and non-transitory computer-readable medium described herein may further include operations, features, means, or instructions for outputting, to the UE, an indication of a reconfiguration of a slot structure for the first resources, the indication including the first length of the cyclic prefix for the first uplink message.

Some examples of the method, network entities, and non-transitory computer-readable medium described herein may further include operations, features, means, or instructions for outputting, to the UE and in response to reception of the first uplink message, an indication to adjust a timing of the UE, a frequency of the UE, or both based on the first timing metric of the UE failing to satisfy the first threshold for the operations according to the first communication mode.

In some examples of the method, network entities, and non-transitory computer-readable medium described herein, outputting the indication may include operations, features, means, or instructions for outputting, to the UE, a timing adjustment command, a frequency adjustment command, or both.

In some examples of the method, network entities, and non-transitory computer-readable medium described herein, outputting the indication may include operations, features, means, or instructions for outputting, to the UE, a DCI message that includes the indication to adjust the timing of the UE, the frequency of the UE, or both and an indication of the second resources for the second uplink message.

In some examples of the method, network entities, and non-transitory computer-readable medium described herein, an offset between the DCI and the second uplink message may be based on reception of the indication via the DCI.

In some examples of the method, network entities, and non-transitory computer-readable medium described herein, the type of message of the second uplink message may be a first type of message associated with the first communication mode based on the second timing metric of the UE satisfying the first threshold for the operations according to the first communication mode for the second resources or may be a second type of message associated a reestablishment of the first communication mode based on the second timing metric of the UE failing to satisfy the first threshold for the operations according to the first communication mode for the second resources.

In some examples of the method, network entities, and non-transitory computer-readable medium described herein, obtaining the second uplink message may include operations, features, means, or instructions for obtaining, from the UE, a request for an uplink timing advance command, a request for a frequency adjustment command, a request for one or more additional instances of a downlink reference signal, or any combination thereof.

Some examples of the method, network entities, and non-transitory computer-readable medium described herein may further include operations, features, means, or instructions for obtaining the request may be via a random access message, a scheduling request message, an uplink control channel message, an uplink data channel message, or any combination thereof.

In some examples of the method, network entities, and non-transitory computer-readable medium described herein, the UE operates within the second communication mode based on a mobility metric of the UE.

A method for wireless communications by a UE is described. The method may include receiving, from a network entity, a control message indicating that the network entity has switched from a first communication mode associated with a first set of timing conditions to a second communication mode associated with a second set of timing conditions, the control message including an indication of the second set of timing conditions, transmitting, to the network entity, a request for one or more additional instances of a downlink reference signal based on a satisfaction of one or more conditions, and receiving, from the network entity, the one or more additional instances of the downlink reference signal based on transmission of the request.

A UE for wireless communications is described. The UE may include one or more memories storing processor executable code, and one or more processors coupled with the one or more memories. The one or more processors may individually or collectively be operable to execute the code to cause the UE to receive, from a network entity, a control message indicating that the network entity has switched from a first communication mode associated with a first set of timing conditions to a second communication mode associated with a second set of timing conditions, the control message including an indication of the second set of timing conditions, transmit, to the network entity, a request for one or more additional instances of a downlink reference signal based on a satisfaction of one or more conditions, and receive, from the network entity, the one or more additional instances of the downlink reference signal based on transmission of the request.

Another UE for wireless communications is described. The UE may include means for receiving, from a network entity, a control message indicating that the network entity has switched from a first communication mode associated with a first set of timing conditions to a second communication mode associated with a second set of timing conditions, the control message including an indication of the second set of timing conditions, means for transmitting, to the network entity, a request for one or more additional instances of a downlink reference signal based on a satisfaction of one or more conditions, and means for receiving, from the network entity, the one or more additional instances of the downlink reference signal based on transmission of the request.

A non-transitory computer-readable medium storing code for wireless communications is described. The code may include instructions executable by one or more processors to receive, from a network entity, a control message indicating that the network entity has switched from a first communication mode associated with a first set of timing conditions to a second communication mode associated with a second set of timing conditions, the control message including an indication of the second set of timing conditions, transmit, to the network entity, a request for one or more additional instances of a downlink reference signal based on a satisfaction of one or more conditions, and receive, from the network entity, the one or more additional instances of the downlink reference signal based on transmission of the request.

In some examples of the method, UEs, and non-transitory computer-readable medium described herein, the one or more conditions include a threshold time condition, a traffic priority condition, a level of mobility condition, a location condition, a beam change condition, a timing metric condition, or any combination thereof.

In some examples of the method, UEs, and non-transitory computer-readable medium described herein, satisfaction of the threshold time condition may be based on a time since a reception of an adjustment command satisfying the threshold time condition.

In some examples of the method, UEs, and non-transitory computer-readable medium described herein, satisfaction of the traffic priority condition may be based on being scheduled with uplink traffic associated with a priority level that satisfies a traffic priority threshold.

In some examples of the method, UEs, and non-transitory computer-readable medium described herein, satisfaction of the level of mobility condition may be based on a level of mobility of the UE satisfying a threshold level of mobility.

In some examples of the method, UEs, and non-transitory computer-readable medium described herein, satisfaction of the location condition may be based on the UE moving a threshold distance away from the network entity.

In some examples of the method, UEs, and non-transitory computer-readable medium described herein, satisfaction of the beam change condition may be based on a change of a beam used by the UE.

In some examples of the method, UEs, and non-transitory computer-readable medium described herein, satisfaction of the timing metric condition may be based on the UE failing to satisfy a threshold for operations according to the second communication mode.

In some examples of the method, UEs, and non-transitory computer-readable medium described herein, the timing metric condition may be associated with a respective carrier frequency of the network entity, a respective downlink signal, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show an example of a wireless communications system that supports uplink timing and frequency adjustment based on energy saving modes in accordance with one or more aspects of the present disclosure.

FIG. 3 shows an example of a process flow that supports uplink timing and frequency adjustment based on energy saving modes in accordance with one or more aspects of the present disclosure.

FIG. 4 shows an example of a wireless communications system that supports uplink timing and frequency adjustment based on energy saving modes in accordance with one or more aspects of the present disclosure.

FIG. 5 shows an example of a process flow that supports uplink timing and frequency adjustment based on energy saving modes in accordance with one or more aspects of the present disclosure.

FIGS. 6 and 7 show block diagrams of devices that support uplink timing and frequency adjustment based on energy saving modes in accordance with one or more aspects of the present disclosure.

FIG. 8 shows a block diagram of a communications manager that supports uplink timing and frequency adjustment based on energy saving modes in accordance with one or more aspects of the present disclosure.

FIG. 9 shows a diagram of a system including a device that supports uplink timing and frequency adjustment based on energy saving modes in accordance with one or more aspects of the present disclosure.

FIGS. 10 and 11 show block diagrams of devices that support uplink timing and frequency adjustment based on energy saving modes in accordance with one or more aspects of the present disclosure.

FIG. 12 shows a block diagram of a communications manager that supports uplink timing and frequency adjustment based on energy saving modes in accordance with one or more aspects of the present disclosure.

FIG. 13 shows a diagram of a system including a device that supports uplink timing and frequency adjustment based on energy saving modes in accordance with one or more aspects of the present disclosure.

FIGS. 14 through 17 show flowcharts illustrating methods that support uplink timing and frequency adjustment based on energy saving modes in accordance with one or more aspects of the present disclosure.

### DETAILED DESCRIPTION

In some wireless communication systems, user equipments (UEs) may be expected to maintain uplink timing and ensure that an uplink frequency error is within a respective range. In some examples, UEs may monitor for and measure one or more downlink reference signals from a network entity to adjust a timing of the UE, a frequency of the UE, or both. Further, a network entity may be expected to provide an uplink timing advance command to the UE as the UE moves to ensure that the uplink timing, frequency, or both is maintained. For example, as UEs move within a coverage area or between cells, the uplink timing and frequency of the UE may become misaligned which may result in communication latency or radio link failures. However, such procedures of a UE monitoring for downlink reference signals and uplink timing advance commands may consume relatively large quantities of power at both the UE and the network entity and may cause an increase in a signaling overhead which can result in an increase in latency and decrease in efficiency and reliability of the wireless communications system.

To improve the efficiency and reliability of wireless communication systems and to improve power savings at one or both of the UE and the network entity, the techniques of the present disclosure describes establishing one or more additional timing and frequency error accuracy ranges for the UE. For example, the network entity may configure the UE with a set of timing and frequency error accuracy ranges to utilize while operating within power saving. Based on configuring the UE with the set of timing and frequency error accuracy ranges, in accordance with the techniques of the present disclosure, the UE may be capable of refraining from monitoring for downlink reference signals as frequently and the network entity may be capable of refraining from transmitting the downlink reference signals and uplink timing advance commands as frequently. In some cases, such ranges may be referred to as relatively relaxed or broader ranges as the UE may be capable of having relatively larger levels of timing and frequency error, or going relatively longer time periods between correction of timing and frequency error, without triggering a random access procedure to reestablish a connection with the network entity. Additionally, or alternatively, power consumption levels at the UE or network entity may also be reduced as random access procedures may consume a relatively large quantity of time and power. Further, utilizing a respective range may be referred to as operating within a communication mode that is associated with a threshold for operations according the communication mode. For example, a first communication mode may be associated with a standard timing and frequency error range and the range may be indicated via a first threshold. Further, a second communication mode may be associated with a relatively broader timing and frequency error range that is indicated via a second threshold.

Thus, while operating in the second communication mode, a UE may transmit a first uplink message to a network entity via a first set of resources of an uplink data channel (e.g., a physical uplink shared channel (PUSCH)) or an uplink control channel (e.g., a physical uplink control channel (PUCCH)). Further, for the first set of resources, a first timing metric of the UE may fail to satisfy the first threshold for operations according to the first communication mode. Moreover, the UE may transmit a second uplink message to the network entity via a second set of resources where a type of message of the second uplink message is based on whether a second timing metric of the UE satisfies the first threshold. For example, if the timing, frequency, or both of the UE fails to satisfy the first threshold, the network entity, the UE, or both may determine to adjust the timing and frequency of the UE for subsequent communications such that the UE operates within the first communication mode. In some cases, adjusting the timing and frequency of the UE may include the network entity transmitting one or more adjustment commands to the UE, the UE requesting for additional downlink reference signals or uplink timing advance commands, or both. Absent any indication of an issue with the timing and frequency of the UE, the UE may determine (e.g., assume) that the timing and frequency of the UE is sufficient and may remain within a respective communications mode to further enhance the power savings of the UE. Thus, the techniques of the present disclosure may enable wireless devices (e.g., UEs and network entities) to reduce levels of power consumption for operating in power saving modes while ensuring that a timing, frequency, or both of the UE can be adjusted accordingly for subsequent communications.

Aspects of the disclosure are initially described in the context of wireless communications systems. Additional aspects of the disclosure are described with reference to wireless communications systems and process flows. Aspects of the disclosure are further illustrated by and described with reference to apparatus diagrams, system diagrams, and flowcharts that relate to uplink timing and frequency adjustment based on energy saving modes.

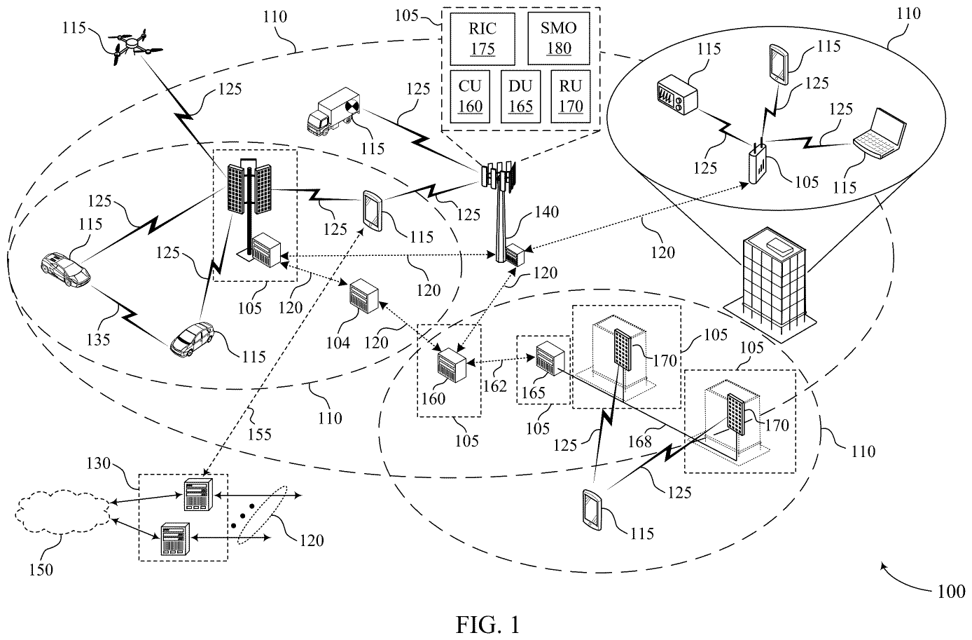

FIG. 1 shows an example of a wireless communications system 100 that supports uplink timing and frequency adjustment based on energy saving modes in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support uplink timing and frequency adjustment based on energy saving modes as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, to improve the efficiency and reliability of the wireless communications system 100 and to improve power savings at both a UE 115 and a network entity 105, the techniques of the present disclosure may describe establishing one or more additional timing or frequency error accuracy ranges for the UE 115. For example, the network entity 105 may configure the UE 115 with a set of timing and frequency error accuracy ranges to utilize while operating within power saving modes such that the UE 115 may be capable of refraining from monitoring for downlink reference signals as frequently and the network entity 105 may be capable of refraining from transmitting the downlink reference signals or uplink timing advance commands as frequently. In some cases, such ranges may be referred to as relatively relaxed or broader ranges as the UE 115 may be capable of having relatively larger levels of timing and frequency error, or going longer time periods between correction of timing and frequency error, without triggering a random access procedure to reestablish a connection with the network entity 105. The relatively relaxed ranges may conserve power as random access procedures may consume a relatively large quantity of time and power. Further, utilizing a respective range may be referred to as operating within a communication mode that is associated with a threshold for operations according the communication mode. For example, a first communication mode may be associated with a standard timing and frequency error range and the range may be indicated via a first threshold. Further, a second communication mode may be associated with a relatively broader timing and frequency error range that is indicated via a second threshold.

Thus, while operating in the second communication mode, a UE 115 may transmit a first uplink message to a network entity 105 via a first set of resources of an uplink data channel (e.g., PUSCH) or an uplink control channel (e.g., a PUCCH). Further, for the first set of resources, a first timing metric of the UE 115 may fail to satisfy the first threshold for operations according to the first communication mode. Moreover, the UE 115 may transmit a second uplink message to the network entity 105 via a second set of resources where a type of message of the second uplink message is based on whether a second timing metric of the UE 115 satisfies the first threshold. For example, if the timing, frequency, or both of the UE 115 fails to satisfy the first threshold for the first set of resources, the network entity 105, the UE 115, or both may determine to adjust the timing and frequency of the UE 115 for subsequent communications such that the UE 115 operates within the first communication mode. In some cases, adjusting the timing and frequency of the UE 115 may include the network entity 105 transmitting one or more adjustment commands to the UE 115, the UE 115 requesting for additional downlink reference signals or uplink timing advance commands, or both. Absent any indication of an issue with the timing and frequency of the UE 115, the UE 115 may determine (e.g., assume) that the timing and frequency of the UE 115 is sufficient and may communicate additional messages without adjustment of the timing and frequency to further enhance the power savings of the UE 115. Thus, the techniques of the present disclosure may enable wireless devices (e.g., UEs 115 and network entities 105) to reduce levels of power consumption while operating in power saving modes while ensuring that a timing, frequency, or both of the UE 115 can be adjusted accordingly for subsequent communications.

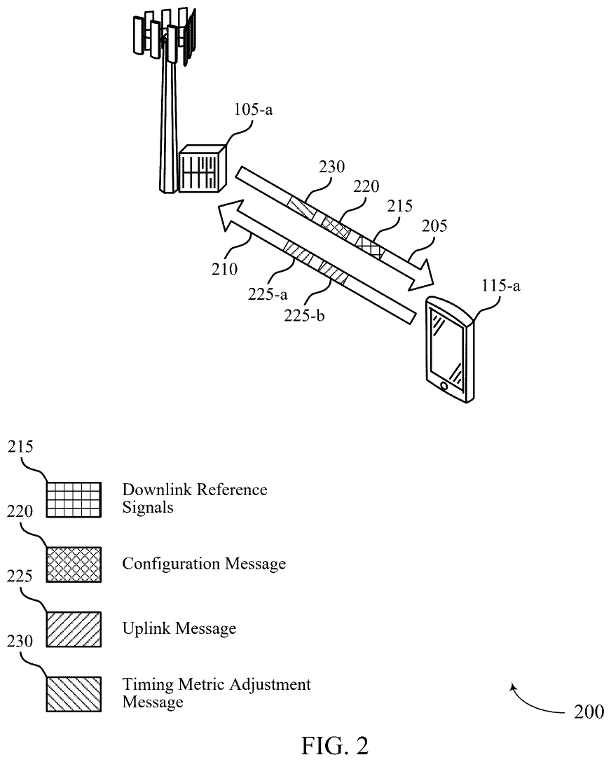

FIG. 2 shows an example of a wireless communications system 200 that supports uplink timing and frequency adjustment based on energy saving modes in accordance with one or more aspects of the present disclosure. In some examples, the wireless communications system 200 may implement or be implemented by the wireless communications system 100. For example, the wireless communications system 200 may include a network entity 105-a and a UE 115-a, which may represent examples of corresponding devices described herein with reference to FIG. 1. The network entity 105-a may communicate with the UE 115-a via a downlink communication link 205 and the UE 115-a may communicate with the network entity 105-a via an uplink communication link 210. The downlink communication link 205 and the uplink communication link 210 may be examples of a Uu link, a sidelink, a backhaul link, a D2D link or some other type of communication link 125 described herein with reference to FIG. 1.

In some examples, the UE 115-a may be expected to maintain an uplink timing value (e.g., timing advance) and ensure that an uplink frequency error is within a range. For example, the network entity 105-a may configure the UE 115-a with a range for an uplink timing value and an uplink frequency error. In some cases, the range may be a timing parameter such as a timing alignment timer value. For example, when the time between timing advance updates is within the timing alignment timer, the UE 115-a is considered to be maintaining synchronization. Further, if the timing alignment timer expires, the UE may be considered to be out of synchronization. In some cases, if the UE 115-a fails to satisfy a threshold associated with the value ranges (e.g., expiration of the timing alignment timer), the UE 115-a, the network entity 105-a, or both may determine that a random access procedure (e.g., a two-step or a four-step random access channel (RACH) procedure) should be performed. For example, the UE 115-a may perform the random access procedure to resync the uplink timing with the network entity 105-a and reestablish the uplink communication link 210.

To prevent having to perform a random access procedure, the UE 115-a may monitor the downlink communication link 205 for one or more downlink reference signals 215 from the network entity 105-a to adjust the timing, frequency, or both at the UE 115-a. Further, if the UE 115-a moves around within a cell or coverage area associated with the network entity 105-a, the network entity 105-a may be expected to provide uplink timing advance commands to the UE 115-a relatively frequently. For example, if the UE 115-a is unable to receive an uplink timing advance command from the network entity 105-a within a duration of the timing alignment timer, the UE 115-a may determine that an uplink synchronization has been lost and the UE 115-a may be expected to perform a random access procedure to resynchronize with the network entity 105-a. In some cases, the network entity 105-a may signal a duration of the timer to the UE 115-a, the UE 115-a may configure the duration of the timer, the UE 115-a and the network entity 105-a may negotiate (e.g., communicate) to establish or configure the duration of the timer, or any combination thereof.

In some examples of the wireless communications system 200, if the UE 115-a, the network entity 105-a, or both, are within an energy savings mode (e.g., a lower power mode as described elsewhere herein such as with reference to FIG. 1), utilizing a relatively broader accuracy range for uplink timing and uplink frequency may result in additional power savings. For example, in accordance with the techniques of the present disclosure, the network entity 105-a may configure the UE 115-a to use a relatively relaxed uplink timing and uplink frequency accuracy range. For example, the network entity 105-a may generate an accuracy range with a relatively higher value for an upper bound and a relatively lower value for a lower bound. Such range may enable the UE 115-a to operate relatively longer without being expected to perform one or more timing adjustments or a random access procedure to resynchronize with the network entity 105-a, thus enhancing the energy and power savings at the UE 115-a. For example, utilizing such range, the UE 115-a may be capable of monitoring the downlink communication link 205 relatively less frequently during relatively long idle periods in a connected mode, thus resulting in additional power savings during the idle periods. Additionally, or alternatively, in accordance with the techniques of the present disclosure, the network entity 105-a may reduce the frequency of transmitting uplink timing advance commands thus reducing the associated overhead on the downlink communication link 205 and the energy consumption at the network entity 105-a and the UE 115-a.

In accordance with the techniques of the present disclosure, the network entity 105-a may configure the UE 115-a with one or more ranges of timing and frequency error (e.g., ranges for timing error, ranges for frequency error, or ranges for both timing error and frequency error) where the UE 115-a is expected to maintain a transmission timing and frequency error within an associated range. In some cases, one or more ranges may be relatively more relaxed compared to others or compared to nominal timing error and frequency error expectations, as described elsewhere herein. Further, the UE 115-a may utilize such ranges when the UE 115-a, the network entity 105-a, or both are within an energy savings mode. Such ranges described herein may also be considered as and referred to as communication modes. For example, based on the UE 115-a monitoring a duration from a last received timing advance command (e.g., the UE 115-a is configured to operate in accordance with a first timing and frequency error accuracy range with an upper and lower bound), the UE 115-a may be considered as operating in a first communication mode with one or more thresholds. Further, satisfaction of the one or more thresholds of a respective communication mode may indicate that the UE 115-a is operating with a timing and frequency that is within the error accuracy range of the respective communication mode. Thus, failing to satisfy a threshold of a respective communication mode may indicate that the UE 115-a is unable to maintain the timing error, frequency error, or both with respect to an upper or lower bound for the error values.

In some examples, the network entity 105-a may configure the UE 115-a with multiple different communication modes (e.g., multiple different error accuracy ranges) via a configuration message 220. For example, the configuration message 220 may configure the UE 115-a with a first communication mode associated with a first threshold for operating within the first communication mode and a second communication mode associated with a second threshold for operating within the second communication mode. As described herein, the first communication mode may refer to a relatively stringent or strict error accuracy range (e.g., the upper and lower bounds of the range may be relatively close to each other). Moreover, the second communication mode may be associated with a relatively broader error accuracy range (e.g., the upper and lower bounds of the range may be relatively farther apart from each other). However, it should be understood by one having ordinary skill in the art that there may be more than two communication modes each associated with a different threshold for operating within the respective communication mode that is associated with a different error accuracy range.

Moreover, in some examples, the configuration message 220 may be cell-specific. For example, if the network entity 105-a is within a network energy savings mode, the network entity 105-a may configure all the UEs 115 within a specific communication mode or error accuracy range. In some other examples, the configuration message 220 may be group-specific (e.g., specific to a group of UEs 115) or UE-specific based on being associated with UE 115 power savings. In some cases, if the configuration message 220 is group-specific, the group of UEs 115 may be determined based on one or more shared characteristics between one or more UEs 115. For example, one or more UEs 115 may each be associated with a same vendor or a same deployment configuration, the one or more UEs 115 may have similar hardware, the one or more UEs 115 may be associated with a same wireless service provider, and the like.

In another example, the configuration message 220 may also be implicit or joint with an indication, a configuration, an activation, a deactivation, or any combination thereof of an energy savings mode. For example, the network entity 105-a may transmit an indication, a configuration, an activation, or a deactivation of a discontinuous reception (DRX) mode (e.g., a continuous-DRX (C-DRX) mode) that also includes the indication of the one or more communication modes and the associated thresholds for the one or more communication modes. Further, the network entity 105-a may transmit an indication, a configuration, an activation, or a deactivation of a cell discontinuous transmission (DTX) mode or a cell DRX mode (e.g., a cell DTX/DRX mode) that also includes the indication of the one or more communication modes and the associated thresholds for the one or more communication modes. In some cases, rather than explicitly including the indications of the one or more communication modes, the indication may be implicit within the messages associated with the respective energy savings mode. In some other cases, the indications of the configuration message 220 may be transmitted jointly with the messages associated with the respective energy savings mode.

Additionally, or alternatively, the UE 115-a may also suggest or request a change in the timing and frequency error expectations, suggest one or more communication modes, or both. For example, the UE 115-a may suggest that based on one or more conditions of the UE 115-a and the network entity 105-a, that the UE 115-a use a different error accuracy range (e.g., a different communication mode) while in an energy savings mode. In another example, based on receiving the configuration message 220, the UE 115-a may suggest that the UE 115-a operate within a respective communication mode indicated via the configuration message.

In some cases, the network entity 105-a may configure the UE 115-a, or the UE 115-a may determine, to use the second communication mode (e.g., a communication mode associated with a relaxed range for one or more timing accuracy range) for an uplink message 225 (e.g., uplink message 225-a). In some examples, the configuration or determination may indicate for the second communication mode to be effective for transmission of the uplink message 225-a (e.g., a scheduling request, a configured grant (CG)-PUSCH message, a dedicated grant (DG)-PUSCH message, or any combination thereof) from the UE 115-a after a relatively long inactive period. For example, if the UE 115-a is configured with an energy saving mode that has a relatively long inactive period, the UE 115-a may determine or the UE 115-a may be configured to use the second communication mode during the inactive period. Thus, the UE 115-a may transmit the uplink message 225-a to the network entity 105-a while operating in the second communication mode. In some cases, after transmission of the uplink message 225-a, the network entity 105-a, the UE 115-a, or both determine that the UE 115-a should adjust a timing or frequency value. Thus, the UE 115-a may utilize the first communication mode (e.g., the communication mode associated with a range with relatively close upper and lower bounds) for transmitting an uplink message 225 that is subsequent to the uplink message 225-a (e.g., an uplink message 225-b).

In some examples, the use of a respective communication mode may be related (e.g., tied to) a cell DTX/DRX configuration, a C-DRX configuration for the UE 115-a, or both. In some cases, the second communication mode (e.g., a communication mode with a relatively relaxed range for timing and frequency error) may be associated with inactive periods or off periods of the cell DTX/DRX configuration, the C-DRX configuration for the UE 115-a, or both. Thus, in some examples, the UE 115-a may determine or be indicated by the network entity 105-a to use the second communication mode during inactive/off periods prior to transmission of the uplink message 225-a (e.g., for scheduling request transmissions). Further, a first communication mode (e.g., a communication mode associated with a relatively more stringent range for timing and frequency error) may be associated with active periods or on periods and can be used for follow-up uplink transmissions or uplink messages 225 (e.g., the uplink message 225-b after the uplink message 225-a). Additionally, or alternatively, a utilization or selection of a respective communication mode may be based on (e.g., depend on) a duration of a DRX/DTX cycle or a duration of an inactive period. For example, for a cycle or period with a duration above a threshold duration, the UE 115-a may utilize the second communication mode (e.g., the UE 115-a may be indicated to use the second communication mode or determine to use the second communication mode). Moreover, in some cases, each communication mode of a set of multiple different communication modes may each be associated with a respective threshold duration for a DTX/DRX cycle or inactive period to assist in determining which communication mode the UE 115-a should utilize.

In some cases, when the UE 115-a utilizes the second communication mode (e.g., a communication mode with a relatively relaxed range for timing and frequency error), an uplink message 225 may be configured accordingly. For example, the UE 115-a may transmit the uplink message 225-a while operating within the second communication mode. In such cases, the uplink message 225-a may be configured with a relatively longer cyclic prefix, a relatively smaller subcarrier spacing (SCS), or both. For example, in a slot, one or more OFDM symbols may have relatively longer cyclic prefixes than other symbols and based on operating within the second communication mode, the UE 115-a may transmit the uplink message 225-a within symbols configured for a relatively longer cyclic prefix.

In another example, the UE 115-a may repeat a first symbol of the uplink message 225-a and the repetition may be used as the cyclic prefix. Such repetition may enable the UE 115-a to accommodate for the timing error of operating within the second communication mode up to a full symbol duration. In some examples, the UE 115-a may perform such symbol repetition for each uplink message 225 that the UE 115-a may transmit while operating in the second communication mode. In some cases, to repeat the first symbol, the UE 115-a may generate the uplink message 225-a such that symbol 0 is a replication of symbol 1. Thus, the UE 115-a may generate the uplink message 225-a such that the cyclic prefix and the data portion for symbol 1 of the uplink message 225-a is the same and copied for the cyclic prefix and the data portion for symbol 0 of the uplink message 225-a. In some other cases, symbol 0 of the uplink message 225-a may be a cyclic prefix extension of symbol 1 of the uplink message 225-a. In such cases, the length of the cyclic prefix of the uplink message 225-a may be increased to the length of symbol 0 and the cyclic prefix of symbol 1. Additionally, or alternatively, when a cell enters a network energy savings mode (e.g., when the network entity 105-a that supports a cell enters a network energy savings mode) the network entity 105-a may reconfigure a slot structure for the cell to enable symbols to have relatively longer cyclic prefixes, to configure a repetition of the first symbol of an uplink message 225, or both. Moreover, in another example, the UE 115-a may utilize an associated preamble (e.g., a front-loaded demodulation reference signal (DMRS) or sounding reference signal (SRS)) that can be used by the network entity 105-a to estimate uplink timing adjustments, uplink frequency adjustments, or both.

In some examples, in response to receiving the uplink message 225-a (e.g., an uplink message 225 transmitted while the UE 115-a is operating within the second communication mode), the network entity 105-a may transmit, via a timing metric adjustment message 230, an indication for the UE 115-a to adjust an uplink timing, an uplink frequency, or both. For example, the network entity 105-a may transmit, to the UE 115-a via the timing metric adjustment message 230, a timing adjustment command (e.g., an updated timing advance value), a frequency adjustment command, or both. In some examples, the network entity 105-a may transmit the timing metric adjustment message 230 (e.g., implicitly or explicitly) to the UE 115-a to indicate whether the UE 115-a should adjust the frequency, timing, or both at the UE 115-a. For example, the timing metric adjustment message 230 may indicate for the UE 115-a to adjust a timing metric (e.g., a timing, frequency, or both) by further retuning the timing, frequency, or both of the UE 115-a using one or more downlink reference signals 215 (e.g., synchronization signal blocks (SSBs), channel state information (CSI)-reference signals (CSI-RSs), tracking reference signals (TRSs), and the like).

In some cases, the network entity 105-a may also transmit the timing metric adjustment message 230 via a downlink control information (DCI) message (e.g., a DCI that indicates a grant for follow-up uplink resources for the uplink message 225-b). If the network entity 105-a transmits the timing metric adjustment message 230 via an uplink-grant DCI, an offset (e.g., a minimum offset) between the DCI and resources for a subsequent PUSCH (e.g., the uplink message 225-b) may be relatively longer. Moreover, the length of the offset may be based on an amount of the indicated adjustments (e.g., timing adjustments, frequency adjustments, or both). Additionally, or alternatively, absence of the network entity 105-a transmitting the timing metric adjustment message 230, the UE 115-a may determine that the uplink timing and uplink frequency (e.g., uplink timing metric) satisfies a threshold (e.g., a threshold associated with the second communication mode, the first communication mode, or both) and is sufficiently accurate (e.g., within a relatively normal range) for communications. Moreover, based on an absence of a timing metric adjustment message 230, the UE 115-a may determine to further adjust an uplink transmission configuration (e.g., a cyclic prefix size, a preamble transmission, and the like) for subsequent uplink transmissions (e.g., for the uplink message 225-b). For example, the UE 115-a may determine that the UE 115-a can use a different communication mode that can further reduce power and energy consumption at the UE 115-a.

In response to receiving the timing metric adjustment message 230 or the UE 115-a, the network entity 105-a, or both determining that the UE 115-a has failed to satisfy a threshold associated with a communication mode (e.g., the first communication mode), the UE 115-a may perform one or more actions via the uplink message 225-b. For example, in some cases, the UE 115-a may determine that the UE 115-a should maintain a respective timing and frequency error range and may determine to perform one or more downlink measurements. In some other cases, the UE 115-a may transmit, via the uplink message 225-b, a request for an uplink timing advance command, a frequency adjustment command, or both. In some examples, the UE 115-a may transmit the uplink message 225-b that includes the request via a random access message (e.g., a RACH message) or via a scheduling request message, a control channel message (e.g., a PUCCH message), a shared channel message (e.g., a PUSCH message), or any combination thereof. In some cases, if the timing and frequency error is satisfies (e.g., is above or beyond) a respective threshold, the UE 115-a may transmit, via the uplink message 225-b, a request for an on-demand TRS, SSB, CSI-RS, SRS, or any combination thereof.

In some cases, the UE 115-a may also perform the timing metric adjustments autonomously. For example, while operating within the second communication mode, the UE 115-a may adjust an uplink synchronization timer accordingly. In some cases, the UE 115-a may set or configure a value of the uplink synchronization timer to an infinite value such that the timer is unable to expire and indicate that the UE 115-a is out of sync with the network entity 105-a. In such cases, the network entity 105-a may configure the UE 115-a to use an open-loop adjustment procedure. The open-loop adjustment procedure may enable the UE 115-a to perform autonomous adjustments (e.g., timing adjustments, frequency adjustments, or both) to compensate for changes in a round-trip-time (RTT). Further, the UE 115-a may perform such autonomous adjustments using downlink measurements, location, speed, and trajectory information, and the like.

Moreover, the UE 115-a may be configured to perform such autonomous adjustments within a respective range or duration. For example, the network entity 105-a may configure or indicate the UE 115-a with an autonomous adjustment range (e.g., a range that the UE 115-a is capable of autonomously adjusting a timing metric), an autonomous adjustment duration (e.g., a duration of time that the UE 115-a is able to autonomously adjust a timing metric), or both. If an autonomous adjustment would exceed the autonomous adjustment range, if the autonomous adjustment duration expires, or both, the UE 115-a may be configured to transmit, via the uplink message 225-b, a demand for an uplink timing advance command from the network entity 105-a. For example, the network entity 105-a may configure the UE 115-a with a set or ordered sequence of adjustments for the UE 115-a to perform and the UE 115-a may perform one or adjustments within the respective set of following the respective sequence. Thus, if an adjustment outside of the set of configured adjustments is expected, the respective sequence of adjustments is completed, or both, the UE 115-a may transmit, via the uplink message 225-b, the request for the uplink timing advance command.

In some examples, such techniques of the present disclosure may be configured for or enabled for low-mobility UEs 115 or pseudo-stationary UEs 115 (e.g., a customer premise equipment (CPE)). Further, UEs 115 (e.g., the UE 115-a) may be expected to fall back to previous operations if a level of mobility of the UE 115 satisfies a configured or indicated threshold. For example, if the speed of the UE 115-a (e.g., the acceleration, the velocity, or the like) or variations of radio frequency measurements from the UE 115-a indicate that the UE 115-a is moving relatively fast, the network entity 105-a may refrain from enabling the UE 115-a with the capability of operating with the second communication mode. For example, if the UE 115-a operates within the second communication mode while moving at a relatively fast speed, the UE 115-a may have to switch between communication modes relatively frequently which can result in an increase in latency and signaling overhead.

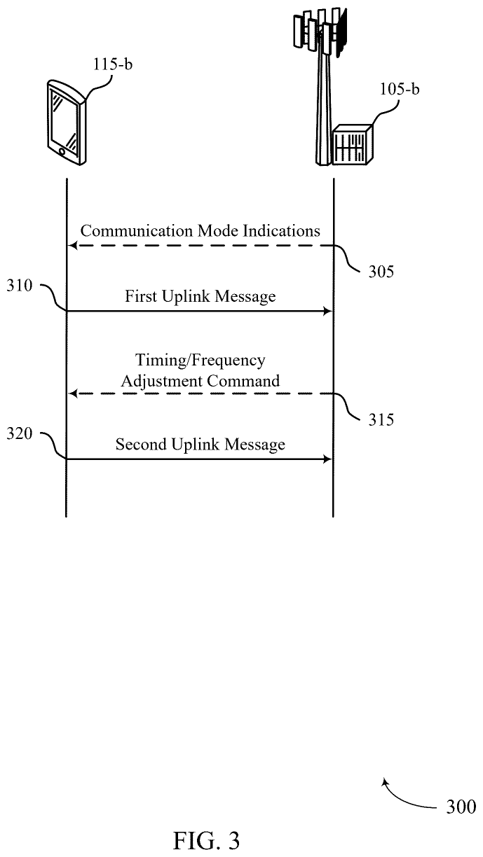

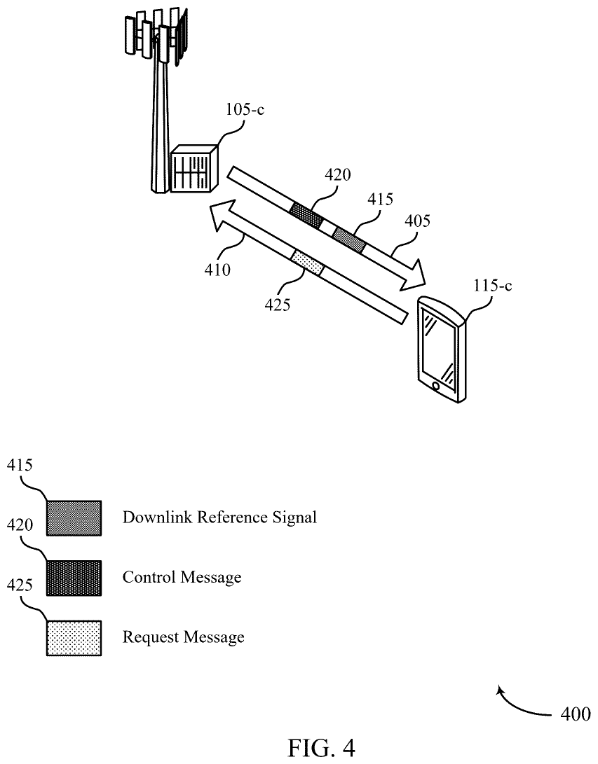

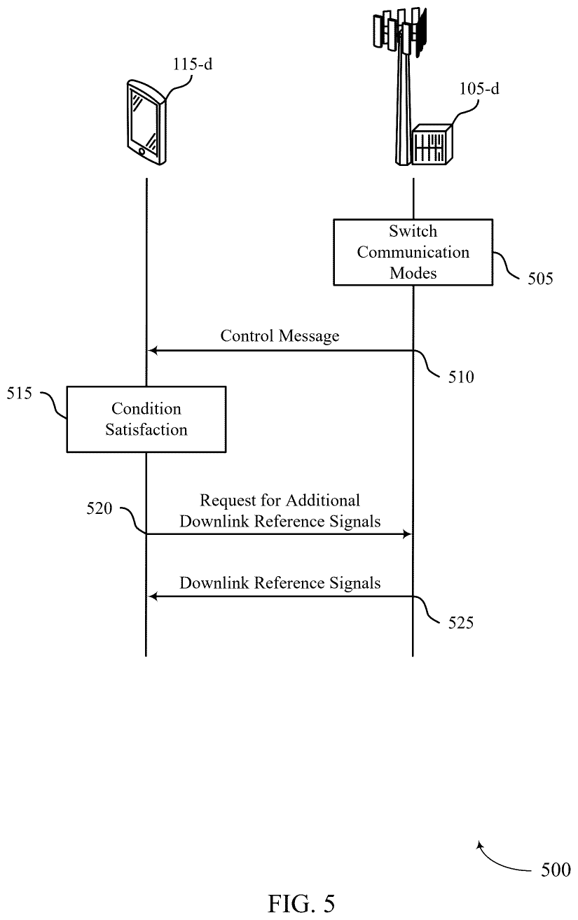

Therefore, as described herein, the techniques of the present disclosure may improve the energy savings of the UE 115-a and the network entity 105-a and may enable the network entity 105-a and the UE 115-a to ensure that the uplink timing and uplink frequency are reliable for communications within the wireless communications system 200. Further descriptions of the techniques of the present disclosure may be described elsewhere herein, such as with reference to FIGS. 3 through 5. Moreover, descriptions of a UE 115 determining to request for additional downlink reference signals 215 from a network entity 105 that is in a network energy savings mode to ensure that an uplink timing and uplink frequency at the UE 115 are maintained may be described elsewhere herein, such as with reference to FIGS. 4 and 5.

FIG. 3 shows an example of a process flow 300 that supports uplink timing and frequency adjustment based on energy saving modes in accordance with one or more aspects of the present disclosure. In some examples, the process flow 300 may implement or be implemented by the wireless communications system 100, the wireless communications system 200, or both. For example, the process flow 300 may include a UE 115-b and a network entity 105-b, which may be examples of devices described herein with reference to FIGS. 1 and 2.

In the following description of the process flow 300, the operations between the UE 115-b and the network entity 105-b may be performed in different orders or at different times. Some operations may also be left out of the process flow 300, or other operations may be added. Although the UE 115-b and the network entity 105-b are shown performing the operations of the process flow 300, some aspects of some operations may also be performed by one or more other wireless devices.

At 305, in some cases, the UE 115-b may receive, from the network entity 105-b, an indication of a first threshold associated with a first communication mode and a second threshold associated with a second communication mode. In some cases, the UE 115-b may receive, from the network entity 105-b and prior to a transmission of a first uplink message, an indication of operation in the second communication mode. Moreover, the indication of operation in the second communication mode may be associated with a cell that includes first resources and second resources, a group of UEs 115, the UE 115-b, or any combination thereof. Further, the UE 115-b may receive the indication of operation in the second communication mode via one or more messages associated with a C-DRX configuration, a cell DTX configuration, a cell DRX configuration, or any combination thereof. Additionally, or alternatively, the UE 115-b may transmit, to the network entity 105-b, a request for operation in the second communication mode.

In some cases, the second communication mode may be associated with an inactive duration, an off duration, or both of a cell DTX configuration, a cell DRX configuration, a C-DRX configuration for the UE 115-b, or any combination thereof. Moreover, the first communication mode may be associated with an active duration, an on duration, or both of the cell DTX configuration, the cell DRX configuration, the C-DRX configuration for the UE 115-b, or any combination thereof. Additionally, or alternatively, the UE 115-b may operate within the second communication mode based on a mobility metric of the UE 115-b. In some cases, prior to, as part of, or after 305 the UE 115-b may receive timing information such as timing advance values for the first communication mode, the second communication mode, or both, and the UE 115-b may determine to relax expectations on timing in the second communication mode.

At 310, the UE 115-b may transmit, while operating in the second communication mode, a first uplink message to the network entity 105-b via first resources of an uplink data channel or an uplink control channel. Moreover, for the first resources, a first timing metric of the UE 115-b may fail to satisfy a first threshold for operations according to a first communication mode. Further, the second communication mode may be associated with a second threshold for the first timing metric.

In some examples, the UE 115-b may select to operate within the second communication mode based on a duration of a cycle, an inactive period, or both of a DRX configuration, a DTX configuration, or both. Thus, the transmission of the first uplink message may be based on the UE 115-b selecting to operate within the second communication mode. In some cases, the first uplink message may have a cyclic prefix of a first length that is based on the UE 115-b operating within the second communication mode. Moreover, the first length may be different from a second length that is associated with the first communication mode based on an indication from the network entity 105-b. For example, the UE 115-b may receive, from the network entity 105-b, an indication of a reconfiguration of a slot structure for the first resources and the indication may include the first length of the cyclic prefix for the first uplink message. In some examples, a first symbol of the first uplink message may be repeated as the cyclic prefix of a second symbol of the first uplink message based on the UE 115-b operating within the second communication mode. Additionally, or alternatively, based on operating within the second communication mode, the UE 115-b may determine to adjust a duration of an uplink synchronization timer.

At 315, the UE 115-b may receive, from the network entity 105-b and in response to the first uplink message, an indication to adjust a timing of the UE 115-b, a frequency of the UE 115-b, or both based on the first timing metric of the UE 115-b failing to satisfy the first threshold for the operations according to the first communication mode. In some cases, the UE 115-b may receive the indication from the network entity 105-b via a timing adjustment command, a frequency adjustment command, or both. In some other cases, the UE 115-b may receive a DCI message from the network entity 105-b that includes the indication to adjust the timing of the UE 115-b, the frequency of the UE 115-b, or both and an indication of the second resources for the second uplink message. Further, an offset between the DCI and the second uplink message may be based on reception of the indication via the DCI. In some examples, based on receiving such indications from the network entity 105-b or based on a determination at the UE 115-b, the UE 115-b may perform one or more timing metric adjustments based on the first timing metric of the UE 115-b failing to satisfy the first threshold for the operations according to the first communication mode. In some cases, the one or more timing metric adjustments may be performed based on the first timing metric being within a respective range, the one or more timing metric adjustments may be performed based on a respective duration from expiration of a timer associated with the first communication mode, or both.

At 320, the UE 115-b may transmit, to the network entity 105-b, a second uplink message via second resources. Further, a type of message of the second uplink message may be based on whether a second timing metric of the UE 115-b satisfies the first threshold for the operations according to the first communication mode for the second resources. In some examples, the type of message of the second uplink message may be a first type of message associated with the first communication mode based on the second timing metric of the UE 115-b satisfying the first threshold for the operations according to the first communication mode for the second resources. For example, the UE 115-b may refrain performing timing metric adjustments prior to transmission of the second uplink message, the second uplink message may have a relatively normal or standard cyclic prefix length, or both. In some other examples, the type of message of the second uplink message may be a second type of message associated with a reestablishment of the first communication mode based at least in part on the second timing metric of the UE 115-b failing to satisfy the first threshold for the operations according to the first communication mode for the second resources. For example, the second uplink message may be a random access message (RACH message) or may indicate a request for additional instances of a downlink reference signal, an uplink timing advance command, or both. Additionally, or alternatively, the UE 115-b may determine that the second timing metric of the UE 115-b satisfies the first threshold for the operations according to the first communication mode for the second resources based on an absence of an indication for adjustment of the first timing metric. In such cases, the second uplink may be associated with a first type of message based at least in part on the determination.

In some examples, via the second uplink message, the UE 115-b may transmit, to the network entity 105-b, a request for an uplink timing advance command, a request for a frequency adjustment command, a request for one or more additional instances of a downlink reference signal, or any combination thereof. Further, the UE 115-b may transmit the request via a random access message, a scheduling request message, an uplink control channel message, an uplink data channel message, or any combination thereof. Additionally, or alternatively, the UE 115-b may transmit, via the second uplink message, a request for an uplink timing advance command based on the first timing metric being outside of a respective range, an expiration of a respective duration, or both.

FIG. 4 shows an example of a wireless communications system 400 that supports uplink timing and frequency adjustment based on energy saving modes in accordance with one or more aspects of the present disclosure. In some examples, the wireless communications system 400 may implement or be implemented by the wireless communications system 100, the wireless communications system 200, or both. For example, the wireless communications system 400 may include a network entity 105-c and a UE 115-c, which may represent examples of corresponding devices described herein with reference to FIG. 1. The network entity 105-c may communicate with the UE 115-c via a downlink communication link 405 and the UE 115-c may communicate with the network entity 105-c via an uplink communication link 410. The downlink communication link 405 and the uplink communication link 410 may be examples of a Uu link, a sidelink, a backhaul link, a D2D link or some other type of communication link 125 described herein with reference to FIG. 1.

In some examples of the wireless communications system 400, the network entity 105-c may operate within one or more energy saving modes which may be referred to herein as communication modes. Further, when the network entity 105-c begins to operate within a network energy savings mode, the network entity 105-c may switch from a first communication mode associated with a first set of timing conditions to a second communication mode associated with a second set of timing conditions. Moreover, the first set of timing conditions may include a first transmission periodicity for transmission of a downlink reference signal 415 and the second set of timing conditions may include a second transmission periodicity for transmission of the downlink reference signal 415. Additionally, or alternatively, the second transmission periodicity may be different (e.g., greater than) the first transmission periodicity. Therefore, when the network entity 105-c switches from the first communication mode to the second communication mode, the network entity 105-c may skip transmitting (e.g., increase a transmission periodicity of) one or more instances of the downlink reference signal 415 (e.g., SSB, CSI-RS, TRS, and the like).

Based on switching to the second communication mode, the network entity 105-c may transmit, via the downlink communication link 405 a control message 420 to the UE 115-c to indicate that the network entity 105-c has switched to the second communication mode. The control message 420 may further include an indication of the second set of timing conditions (e.g., the transmission periodicity of the downlink reference signal 415). In response, as described herein with reference to FIG. 2, the UE 115-c may determine to operate within a communication mode associated with relatively broader timing and frequency expectations (e.g., a relatively broader timing and frequency error accuracy range). Moreover, the network entity 105-c may configure the UE 115-c to perform autonomous timing adjustments while the network entity 105-c is operating within the second communication mode.

In some examples, the UE 115-c may transmit, to the network entity 105-c via the uplink communication link 410, a request 425 (e.g., an on-demand request) for one or more additional instances of the downlink reference signal 415 based on a satisfaction of one or more conditions. For example, the UE 115-c may transmit the request 425 based on a threshold duration being satisfied since the network entity 105-c last transmitted a timing adjustment command. In another example, the UE 115-c may transmit the request 425 based on uplink traffic with a relatively high priority (e.g., a priority above a threshold priority) being scheduled or being transmitted. In some cases, the UE 115-c may also transmit the request 425 based on a level of mobility of the UE 115-c changing and satisfying a threshold mobility level. For example, the mobility of the UE 115-c may change relatively rapidly and the UE 115-c may transmit the request based on the mobility of the UE 115-c being above a threshold.

In some examples, the UE 115-c may transmit the request 425 based on a location of the UE 115-c changing and satisfying a distance threshold associated with the network entity 105-c (e.g., being beyond a threshold distance from the network entity 105-c). For example, the UE 115-c may move a threshold distance away from the network entity 105-c and transmit the request 425 to resync with the network entity 105-c. In another example, a beam utilized by the UE 115-c may change and the UE 115-c may transmit the request 425 accordingly. As described with reference to FIG. 2, the UE 115-c may also determine that a timing metric (e.g., a timing, frequency, or both) of the UE 115-c fails to satisfy a threshold (e.g., the timing metric is beyond a signaled accuracy range) and the UE 115-c may transmit the request 425 accordingly. Moreover, the timing and frequency error range utilized by the UE 115-c may be relative to a respective carrier frequency. Additionally, or alternatively, the timing and frequency error range may be relative to a downlink signal.

In response to the request 425, the network entity 105-c may transmit the one or more additional instances of the downlink reference signal 415 to ensure that an uplink timing, uplink frequency, or both can be maintained at the UE 115-c. Such techniques of the present disclosure may enable both the network entity 105-c and the UE 115-c to operate within enhanced energy savings modes and ensure that the uplink timing, uplink frequency, or both of the UE 115-c can be maintained while the network entity 105-c is within a network energy savings mode. Therefore, the techniques of the present disclosure may result in an increase in power savings, efficiency, and reliability of the wireless communications system 400. Further descriptions of the techniques of the present disclosure may be described elsewhere herein such as with reference to FIG. 5.

FIG. 5 shows an example of a process flow 500 that supports uplink timing and frequency adjustment based on energy saving modes in accordance with one or more aspects of the present disclosure. In some examples, the process flow 500 may implement or be implemented by the wireless communications system 100, the wireless communications system 400, or both. For example, the process flow 500 may include a UE 115-d and a network entity 105-d, which may be examples of devices described herein with reference to FIGS. 1 and 3.

In the following description of the process flow 500, the operations between the UE 115-d and the network entity 105-d may be performed in different orders or at different times. Some operations may also be left out of the process flow 500, or other operations may be added. Although the UE 115-d and the network entity 105-d are shown performing the operations of the process flow 500, some aspects of some operations may also be performed by one or more other wireless devices.

At 505, the network entity 105-d may switch from a first communication mode associated with a first set of timing conditions to a second communication mode associated with a second set of timing conditions. Further, the first set of timing conditions may include a first transmission periodicity for transmission of a downlink reference signal and the second set of timing conditions may include a second transmission periodicity for the transmission of the downlink reference signal. Moreover, the second transmission periodicity may be different from (e.g., greater than) the first transmission periodicity.

At 510, the network entity 105-d may output (e.g., transmit), to the UE 115-d a control message indicating that the network entity has switched to the second communication mode. Further, the control message may include an indication of the second set of timing conditions. Moreover, in some cases, in response to reception of the control message, the UE 115-d may also determine to switch to a different communication mode.

At 515, the UE 115-d may determine that one or conditions may be satisfied. In some examples, the one or more conditions may include a threshold time condition, a traffic priority condition, a level of mobility condition, a location condition, a beam change condition, a timing metric condition, or any combination thereof. In some cases, the UE 115-d may determine a satisfaction of the threshold time condition based on a time since a transmission of an adjustment command satisfying the threshold time condition. Further, the UE 115-d may determine that satisfaction of the traffic priority condition may be based on the network entity 105-d scheduling the UE 115-d with uplink traffic associated with a priority level that satisfies a traffic priority threshold. In another example, the UE 115-d may determine that satisfaction of the level of mobility condition may be based on a level of mobility of the UE 115-d satisfying a threshold level of mobility. Moreover, the UE 115-d may determine that satisfaction of the location condition may be based on the UE 115-d moving a threshold distance away from the network entity 105-d.

In another example, the UE 115-d may determine that satisfaction of the beam change condition may be based at least in part on a change of a beam used by the UE 115-d. In a different example, the UE 115-d may determine that satisfaction of the timing metric condition may be based on the UE 115-d failing to satisfy a threshold for operations according to the first communication mode. Moreover, the timing metric condition may be associated with a respective carrier frequency of the network entity 105-d, a cell associated with the downlink reference signal, a beam associated with the downlink reference signal, or any combination thereof.

At 520, the network entity 105-d may obtain (e.g., receive), from the UE 115-d, a request for one or more additional instances of the downlink reference signal based on a satisfaction of one or more conditions. For example, the UE 115-d may transmit the request based on at least one condition being satisfied at 515. At 525, the network entity 105-d may output (e.g., transmit), to the UE 115-d, the one or more additional instances of the downlink reference signal based on reception of the request.

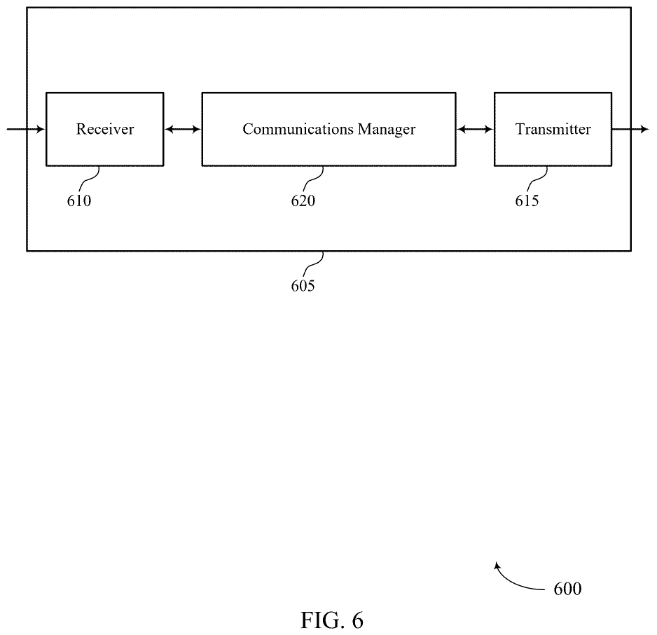

FIG. 6 shows a block diagram 600 of a device 605 that supports uplink timing and frequency adjustment based on energy saving modes in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink timing and frequency adjustment based on energy saving modes). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink timing and frequency adjustment based on energy saving modes). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of uplink timing and frequency adjustment based on energy saving modes as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting, while operating in a second communication mode, a first uplink message to a network entity via first resources of an uplink data channel or an uplink control channel, where, for the first resources, a first timing metric of the UE fails to satisfy a first threshold for operations according to a first communication mode, and where the second communication mode is associated with a second threshold for the first timing metric. The communications manager 620 is capable of, configured to, or operable to support a means for transmitting, to the network entity, a second uplink message via second resources, where a type of message of the second uplink message is based on whether a second timing metric of the UE satisfies the first threshold for the operations according to the first communication mode for the second resources.

Additionally, or alternatively, the communications manager 620 may support wireless communications in accordance with examples as disclosed herein. For example, the communications manager 620 is capable of, configured to, or operable to support a means for receiving, from a network entity, a control message indicating that the network entity has switched from a first communication mode associated with a first set of timing conditions to a second communication mode associated with a second set of timing conditions, the control message including an indication of the second set of timing conditions. The communications manager 620 is capable of, configured to, or operable to support a means for transmitting, to the network entity, a request for one or more additional instances of a downlink reference signal based on a satisfaction of one or more conditions. The communications manager 620 is capable of, configured to, or operable to support a means for receiving, from the network entity, the one or more additional instances of the downlink reference signal based on transmission of the request.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for utilizing one or more communication modes to support reduced processing, reduced power consumption, and more efficient utilization of communication resources.

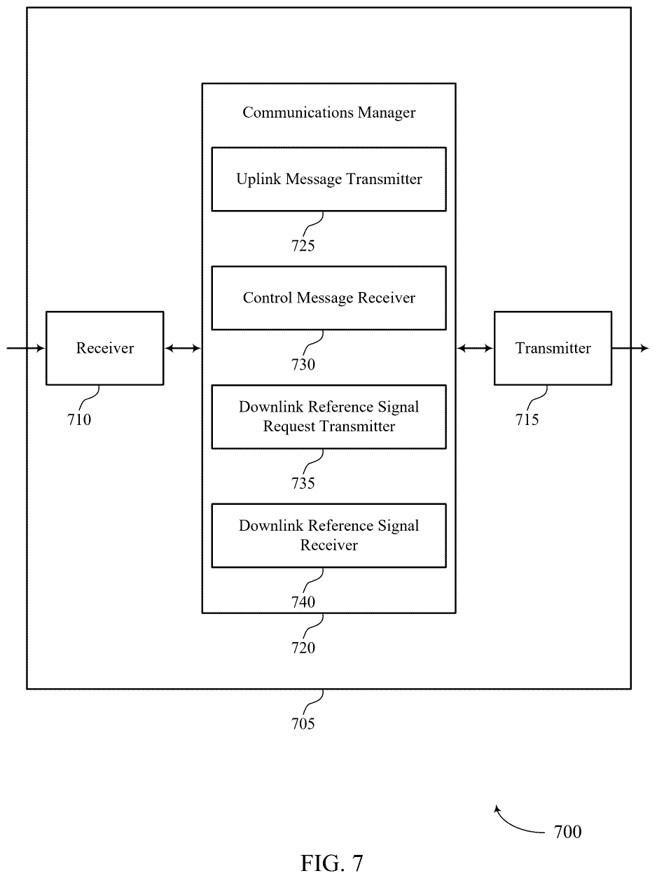

FIG. 7 shows a block diagram 700 of a device 705 that supports uplink timing and frequency adjustment based on energy saving modes in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to uplink timing and frequency adjustment based on energy saving modes). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to uplink timing and frequency adjustment based on energy saving modes). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of uplink timing and frequency adjustment based on energy saving modes as described herein. For example, the communications manager 720 may include an uplink message transmitter 725, a control message receiver 730, a downlink reference signal request transmitter 735, a downlink reference signal receiver 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The uplink message transmitter 725 is capable of, configured to, or operable to support a means for transmitting, while operating in a second communication mode, a first uplink message to a network entity via first resources of an uplink data channel or an uplink control channel, where, for the first resources, a first timing metric of the UE fails to satisfy a first threshold for operations according to a first communication mode, and where the second communication mode is associated with a second threshold for the first timing metric. The uplink message transmitter 725 is capable of, configured to, or operable to support a means for transmitting, to the network entity, a second uplink message via second resources, where a type of message of the second uplink message is based on whether a second timing metric of the UE satisfies the first threshold for the operations according to the first communication mode for the second resources.

Additionally, or alternatively, the communications manager 720 may support wireless communications in accordance with examples as disclosed herein. The control message receiver 730 is capable of, configured to, or operable to support a means for receiving, from a network entity, a control message indicating that the network entity has switched from a first communication mode associated with a first set of timing conditions to a second communication mode associated with a second set of timing conditions, the control message including an indication of the second set of timing conditions. The downlink reference signal request transmitter 735 is capable of, configured to, or operable to support a means for transmitting, to the network entity, a request for one or more additional instances of a downlink reference signal based on a satisfaction of one or more conditions. The downlink reference signal receiver 740 is capable of, configured to, or operable to support a means for receiving, from the network entity, the one or more additional instances of the downlink reference signal based on transmission of the request.

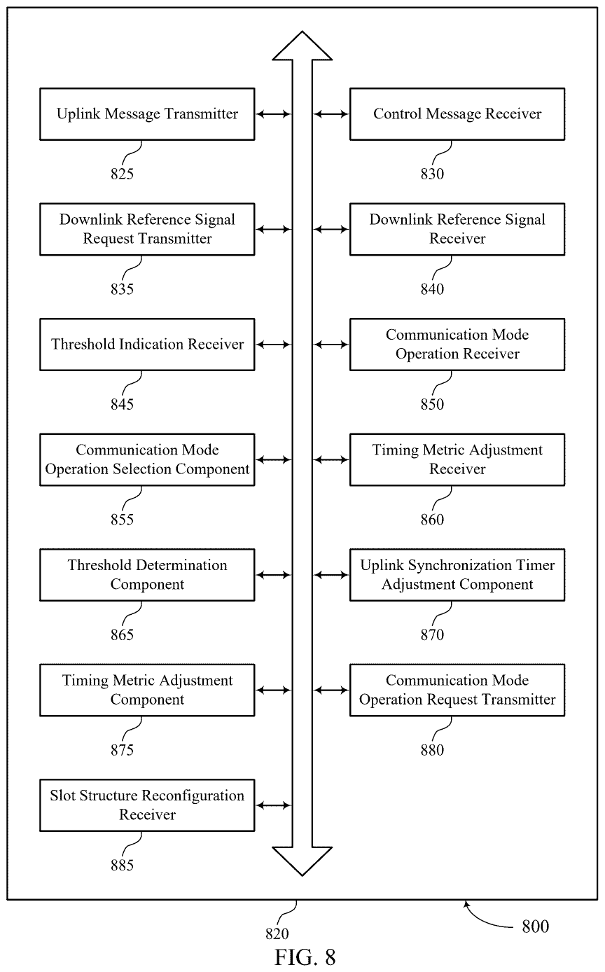

FIG. 8 shows a block diagram 800 of a communications manager 820 that supports uplink timing and frequency adjustment based on energy saving modes in accordance with one or more aspects of the present disclosure. The communications manager 820 may be an example of aspects of a communications manager 620, a communications manager 720, or both, as described herein. The communications manager 820, or various components thereof, may be an example of means for performing various aspects of uplink timing and frequency adjustment based on energy saving modes as described herein. For example, the communications manager 820 may include an uplink message transmitter 825, a control message receiver 830, a downlink reference signal request transmitter 835, a downlink reference signal receiver 840, a threshold indication receiver 845, a communication mode operation receiver 850, a communication mode operation selection component 855, a timing metric adjustment receiver 860, a threshold determination component 865, an uplink synchronization timer adjustment component 870, a timing metric adjustment component 875, a communication mode operation request transmitter 880, a slot structure reconfiguration receiver 885, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The uplink message transmitter 825 is capable of, configured to, or operable to support a means for transmitting, while operating in a second communication mode, a first uplink message to a network entity via first resources of an uplink data channel or an uplink control channel, where, for the first resources, a first timing metric of the UE fails to satisfy a first threshold for operations according to a first communication mode, and where the second communication mode is associated with a second threshold for the first timing metric. In some examples, the uplink message transmitter 825 is capable of, configured to, or operable to support a means for transmitting, to the network entity, a second uplink message via second resources, where a type of message of the second uplink message is based on whether a second timing metric of the UE satisfies the first threshold for the operations according to the first communication mode for the second resources.

In some examples, the threshold indication receiver 845 is capable of, configured to, or operable to support a means for receiving, from the network entity, an indication of the first threshold associated with the first communication mode and the second threshold associated with the second communication mode.

In some examples, the communication mode operation receiver 850 is capable of, configured to, or operable to support a means for receiving, prior to transmitting the first uplink message, an indication of operation in the second communication mode, where the indication of operation in the second communication mode is associated with a cell including the first resources and the second resources, a group of UEs, the UE, or any combination thereof.

In some examples, the indication of operation in the second communication mode is received via one or more messages associated with a continuous-discontinuous reception (C-DRX) configuration, a cell discontinuous transmission (DTX) configuration, a cell DRX configuration, or any combination thereof.

In some examples, the communication mode operation request transmitter 880 is capable of, configured to, or operable to support a means for transmitting, to the network entity, a request for operation in the second communication mode.

In some examples, the second communication mode is associated with an inactive duration, an off duration, or both of a cell discontinuous transmission configuration, a cell discontinuous reception configuration, a continuous-discontinuous reception configuration for the UE, or any combination thereof and the first communication mode is associated with an active duration, an on duration, or both of the cell discontinuous transmission configuration, the cell discontinuous reception configuration, the continuous-discontinuous reception configuration for the UE, or any combination thereof.

In some examples, the communication mode operation selection component 855 is capable of, configured to, or operable to support a means for selecting to operate within the second communication mode based on a duration of a cycle, an inactive period, or both of a discontinuous reception configuration, a discontinuous transmission configuration, or both, where transmission of the first uplink message is based on selecting to operate within the second communication mode.

In some examples, the first uplink message has a cyclic prefix of a first length based on the UE operating within the second communication mode, the first length being different from a second length that is associated with the first communication mode.

In some examples, a first symbol of the first uplink message is repeated as the cyclic prefix of a second symbol of the first uplink message based on the UE operating within the second communication mode.

In some examples, the slot structure reconfiguration receiver 885 is capable of, configured to, or operable to support a means for receiving, from the network entity, an indication of a reconfiguration of a slot structure for the first resources, the indication including the first length of the cyclic prefix for the first uplink message.

In some examples, the timing metric adjustment receiver 860 is capable of, configured to, or operable to support a means for receiving, from the network entity and in response to the first uplink message, an indication to adjust a timing of the UE, a frequency of the UE, or both based on the first timing metric of the UE failing to satisfy the first threshold for the operations according to the first communication mode.

In some examples, to support receiving the indication, the timing metric adjustment receiver 860 is capable of, configured to, or operable to support a means for receiving, from the network entity, a timing adjustment command, a frequency adjustment command, or both.

In some examples, to support receiving the indication, the timing metric adjustment receiver 860 is capable of, configured to, or operable to support a means for receiving, from the network entity, a DCI message that includes the indication to adjust the timing of the UE, the frequency of the UE, or both and an indication of the second resources for the second uplink message.

In some examples, an offset between the DCI and the second uplink message is based on reception of the indication via the DCI.

In some examples, the type of message of the second uplink message is a first type of message associated with the first communication mode based on the second timing metric of the UE satisfying the first threshold for the operations according to the first communication mode for the second resources or is a second type of message associated a reestablishment of the first communication mode based on the second timing metric of the UE failing to satisfy the first threshold for the operations according to the first communication mode for the second resources.

In some examples, the threshold determination component 865 is capable of, configured to, or operable to support a means for determining that the second timing metric of the UE satisfies the first threshold for the operations according to the first communication mode for the second resources based on an absence of an indication for adjustment of the first timing metric, where the second uplink message is associated with a first type of message based on the determination.

In some examples, to support transmitting the second uplink message, the uplink message transmitter 825 is capable of, configured to, or operable to support a means for transmitting, to the network entity, a request for an uplink timing advance command, a request for a frequency adjustment command, a request for one or more additional instances of a downlink reference signal, or any combination thereof.

In some examples, transmission of the request is via a random access message, a scheduling request message, an uplink control channel message, an uplink data channel message, or any combination thereof.

In some examples, the uplink synchronization timer adjustment component 870 is capable of, configured to, or operable to support a means for adjusting a duration of an uplink synchronization timer based on the UE operating within the second communication mode.

In some examples, the timing metric adjustment component 875 is capable of, configured to, or operable to support a means for performing one or more timing metric adjustments based on the first timing metric of the UE failing to satisfy the first threshold for the operations according to the first communication mode, where the one or more timing metric adjustments are performed based on the first timing metric being within a respective range, the one or more timing metric adjustments are performed based on a respective duration from expiration of a timer associated with the first communication mode, or both.

In some examples, the first uplink message, the second uplink message, or both include a request for an uplink timing advance command based on the first timing metric being outside of the respective range, an expiration of the respective duration, or both.

In some examples, the UE operates within the second communication mode based on a mobility metric of the UE.

Additionally, or alternatively, the communications manager 820 may support wireless communications in accordance with examples as disclosed herein. The control message receiver 830 is capable of, configured to, or operable to support a means for receiving, from a network entity, a control message indicating that the network entity has switched from a first communication mode associated with a first set of timing conditions to a second communication mode associated with a second set of timing conditions, the control message including an indication of the second set of timing conditions. The downlink reference signal request transmitter 835 is capable of, configured to, or operable to support a means for transmitting, to the network entity, a request for one or more additional instances of a downlink reference signal based on a satisfaction of one or more conditions. The downlink reference signal receiver 840 is capable of, configured to, or operable to support a means for receiving, from the network entity, the one or more additional instances of the downlink reference signal based on transmission of the request.

In some examples, the one or more conditions include a threshold time condition, a traffic priority condition, a level of mobility condition, a location condition, a beam change condition, a timing metric condition, or any combination thereof.

In some examples, satisfaction of the threshold time condition is based on a time since a reception of an adjustment command satisfying the threshold time condition.

In some examples, satisfaction of the traffic priority condition is based on being scheduled with uplink traffic associated with a priority level that satisfies a traffic priority threshold.

In some examples, satisfaction of the level of mobility condition is based on a level of mobility of the UE satisfying a threshold level of mobility.

In some examples, satisfaction of the location condition is based on the UE moving a threshold distance away from the network entity.

In some examples, satisfaction of the beam change condition is based on a change of a beam used by the UE.

In some examples, satisfaction of the timing metric condition is based on the UE failing to satisfy a threshold for operations according to the second communication mode.

In some examples, the timing metric condition is associated with a respective carrier frequency of the network entity, a respective downlink signal, or both.

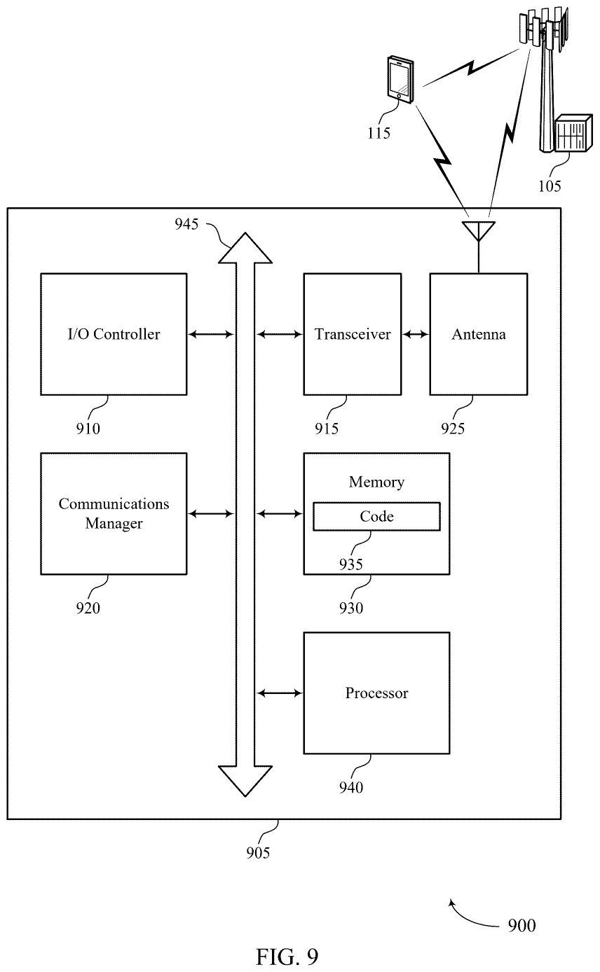

FIG. 9 shows a diagram of a system 900 including a device 905 that supports uplink timing and frequency adjustment based on energy saving modes in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting uplink timing and frequency adjustment based on energy saving modes). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting, while operating in a second communication mode, a first uplink message to a network entity via first resources of an uplink data channel or an uplink control channel, where, for the first resources, a first timing metric of the UE fails to satisfy a first threshold for operations according to a first communication mode, and where the second communication mode is associated with a second threshold for the first timing metric. The communications manager 920 is capable of, configured to, or operable to support a means for transmitting, to the network entity, a second uplink message via second resources, where a type of message of the second uplink message is based on whether a second timing metric of the UE satisfies the first threshold for the operations according to the first communication mode for the second resources.

Additionally, or alternatively, the communications manager 920 may support wireless communications in accordance with examples as disclosed herein. For example, the communications manager 920 is capable of, configured to, or operable to support a means for receiving, from a network entity, a control message indicating that the network entity has switched from a first communication mode associated with a first set of timing conditions to a second communication mode associated with a second set of timing conditions, the control message including an indication of the second set of timing conditions. The communications manager 920 is capable of, configured to, or operable to support a means for transmitting, to the network entity, a request for one or more additional instances of a downlink reference signal based on a satisfaction of one or more conditions. The communications manager 920 is capable of, configured to, or operable to support a means for receiving, from the network entity, the one or more additional instances of the downlink reference signal based on transmission of the request.

By including or configuring the communications manager 920 in accordance with examples as described herein, the device 905 may support techniques for utilizing one or more communication modes to support improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of uplink timing and frequency adjustment based on energy saving modes as described herein, or the at least one processor 940 and the at least one memory 930 may be otherwise configured to, individually or collectively, perform or support such operations.

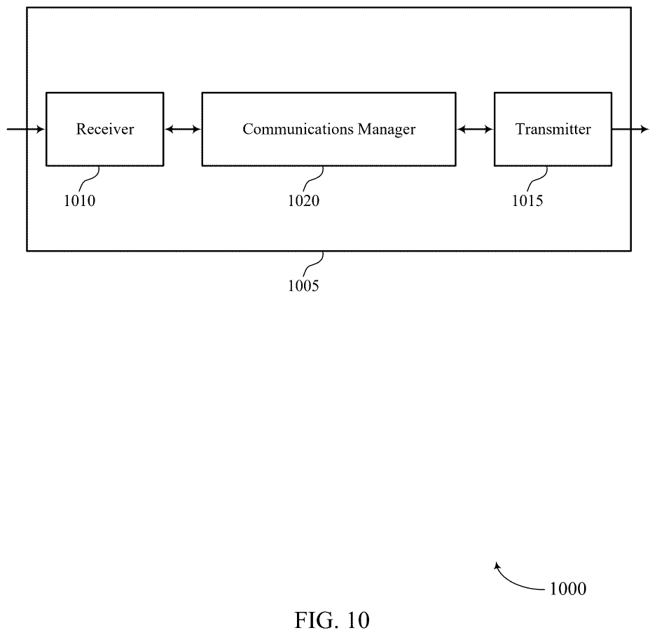

FIG. 10 shows a block diagram 1000 of a device 1005 that supports uplink timing and frequency adjustment based on energy saving modes in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of uplink timing and frequency adjustment based on energy saving modes as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for switching from a first communication mode associated with a first set of timing conditions to a second communication mode associated with a second set of timing conditions, the first set of timing conditions including a first transmission periodicity for transmission of a downlink reference signal and the second set of timing conditions including a second transmission periodicity for the transmission of the downlink reference signal, where the second transmission periodicity is different from the first transmission periodicity. The communications manager 1020 is capable of, configured to, or operable to support a means for outputting, to a UE, a control message indicating that the network entity has switched to the second communication mode, the control message including an indication of the second set of timing conditions. The communications manager 1020 is capable of, configured to, or operable to support a means for obtaining, from the UE, a request for one or more additional instances of the downlink reference signal based on a satisfaction of one or more conditions. The communications manager 1020 is capable of, configured to, or operable to support a means for outputting, to the UE, the one or more additional instances of the downlink reference signal based on reception of the request.

Additionally, or alternatively, the communications manager 1020 may support wireless communications in accordance with examples as disclosed herein. For example, the communications manager 1020 is capable of, configured to, or operable to support a means for obtaining, while a UE is operating in a second communication mode, a first uplink message from the UE via first resources of an uplink data channel or an uplink control channel, where, for the first resources, a first timing metric of the UE fails to satisfy a first threshold for operations according to a first communication mode, and where the second communication mode is associated with a second threshold for the first timing metric. The communications manager 1020 is capable of, configured to, or operable to support a means for obtaining, from the UE, a second uplink message via second resources, where a type of message of the second uplink message is based on whether a second timing metric of the UE satisfies the first threshold for the operations according to the first communication mode for the second resources.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for utilizing one or more communication modes to support reduced processing, reduced power consumption, and more efficient utilization of communication resources.

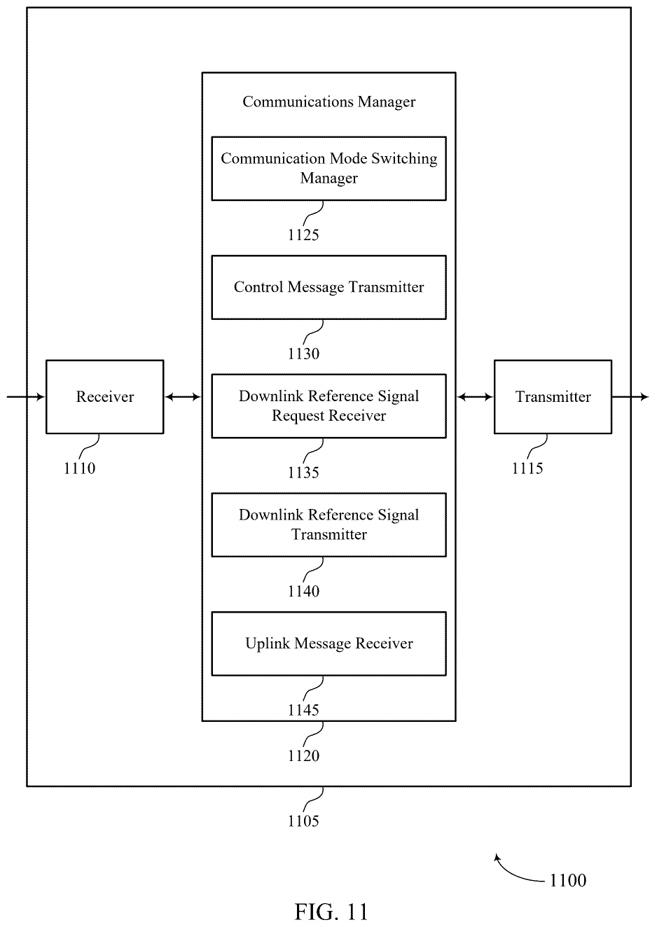

FIG. 11 shows a block diagram 1100 of a device 1105 that supports uplink timing and frequency adjustment based on energy saving modes in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of uplink timing and frequency adjustment based on energy saving modes as described herein. For example, the communications manager 1120 may include a communication mode switching manager 1125, a control message transmitter 1130, a downlink reference signal request receiver 1135, a downlink reference signal transmitter 1140, an uplink message receiver 1145, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The communication mode switching manager 1125 is capable of, configured to, or operable to support a means for switching from a first communication mode associated with a first set of timing conditions to a second communication mode associated with a second set of timing conditions, the first set of timing conditions including a first transmission periodicity for transmission of a downlink reference signal and the second set of timing conditions including a second transmission periodicity for the transmission of the downlink reference signal, where the second transmission periodicity is different from the first transmission periodicity. The control message transmitter 1130 is capable of, configured to, or operable to support a means for outputting, to a UE, a control message indicating that the network entity has switched to the second communication mode, the control message including an indication of the second set of timing conditions. The downlink reference signal request receiver 1135 is capable of, configured to, or operable to support a means for obtaining, from the UE, a request for one or more additional instances of the downlink reference signal based on a satisfaction of one or more conditions. The downlink reference signal transmitter 1140 is capable of, configured to, or operable to support a means for outputting, to the UE, the one or more additional instances of the downlink reference signal based on reception of the request.

Additionally, or alternatively, the communications manager 1120 may support wireless communications in accordance with examples as disclosed herein. The uplink message receiver 1145 is capable of, configured to, or operable to support a means for obtaining, while a UE is operating in a second communication mode, a first uplink message from the UE via first resources of an uplink data channel or an uplink control channel, where, for the first resources, a first timing metric of the UE fails to satisfy a first threshold for operations according to a first communication mode, and where the second communication mode is associated with a second threshold for the first timing metric. The uplink message receiver 1145 is capable of, configured to, or operable to support a means for obtaining, from the UE, a second uplink message via second resources, where a type of message of the second uplink message is based on whether a second timing metric of the UE satisfies the first threshold for the operations according to the first communication mode for the second resources.

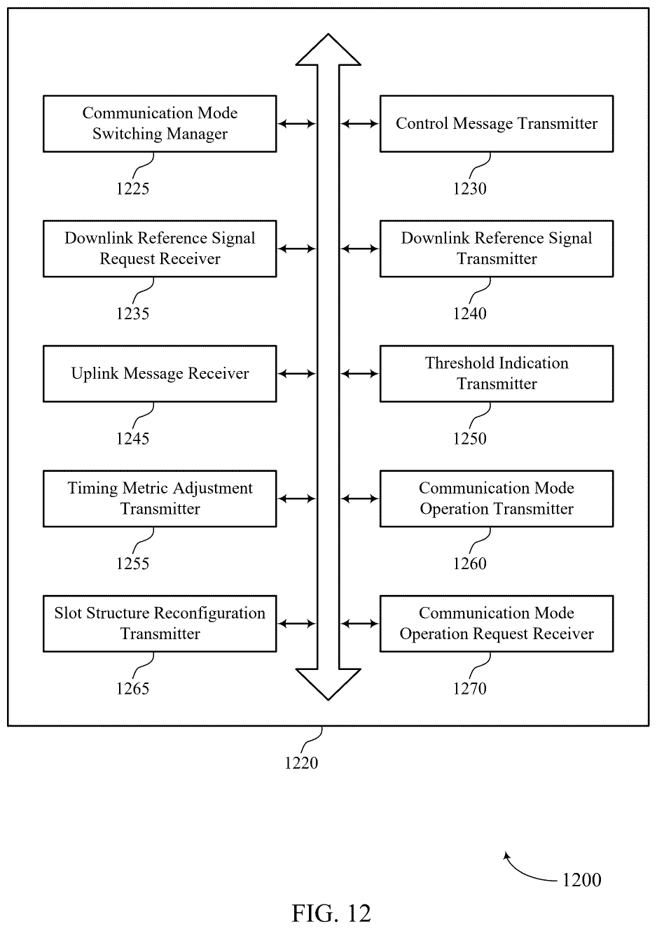

FIG. 12 shows a block diagram 1200 of a communications manager 1220 that supports uplink timing and frequency adjustment based on energy saving modes in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of uplink timing and frequency adjustment based on energy saving modes as described herein. For example, the communications manager 1220 may include a communication mode switching manager 1225, a control message transmitter 1230, a downlink reference signal request receiver 1235, a downlink reference signal transmitter 1240, an uplink message receiver 1245, a threshold indication transmitter 1250, a timing metric adjustment transmitter 1255, a communication mode operation transmitter 1260, a slot structure reconfiguration transmitter 1265, a communication mode operation request receiver 1270, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The communication mode switching manager 1225 is capable of, configured to, or operable to support a means for switching from a first communication mode associated with a first set of timing conditions to a second communication mode associated with a second set of timing conditions, the first set of timing conditions including a first transmission periodicity for transmission of a downlink reference signal and the second set of timing conditions including a second transmission periodicity for the transmission of the downlink reference signal, where the second transmission periodicity is different from the first transmission periodicity. The control message transmitter 1230 is capable of, configured to, or operable to support a means for outputting, to a UE, a control message indicating that the network entity has switched to the second communication mode, the control message including an indication of the second set of timing conditions. The downlink reference signal request receiver 1235 is capable of, configured to, or operable to support a means for obtaining, from the UE, a request for one or more additional instances of the downlink reference signal based on a satisfaction of one or more conditions. The downlink reference signal transmitter 1240 is capable of, configured to, or operable to support a means for outputting, to the UE, the one or more additional instances of the downlink reference signal based on reception of the request.

In some examples, the one or more conditions include a threshold time condition, a traffic priority condition, a level of mobility condition, a location condition, a beam change condition, a timing metric condition, or any combination thereof.

In some examples, satisfaction of the threshold time condition is based on a time since a transmission of an adjustment command satisfying the threshold time condition.

In some examples, satisfaction of the traffic priority condition is based on scheduling the UE with uplink traffic associated with a priority level that satisfies a traffic priority threshold.

In some examples, satisfaction of the level of mobility condition is based on a level of mobility of the UE satisfying a threshold level of mobility.

In some examples, satisfaction of the location condition is based on the UE moving a threshold distance away from the network entity.

In some examples, satisfaction of the beam change condition is based on a change of a beam used by the UE.

In some examples, satisfaction of the timing metric condition is based on the UE failing to satisfy a threshold for operations according to the first communication mode.

In some examples, the timing metric condition is associated with a respective carrier frequency of the network entity, a cell associated with the downlink reference signal, a beam associated with the downlink reference signal, or a combination thereof.

Additionally, or alternatively, the communications manager 1220 may support wireless communications in accordance with examples as disclosed herein. The uplink message receiver 1245 is capable of, configured to, or operable to support a means for obtaining, while a UE is operating in a second communication mode, a first uplink message from the UE via first resources of an uplink data channel or an uplink control channel, where, for the first resources, a first timing metric of the UE fails to satisfy a first threshold for operations according to a first communication mode, and where the second communication mode is associated with a second threshold for the first timing metric. In some examples, the uplink message receiver 1245 is capable of, configured to, or operable to support a means for obtaining, from the UE, a second uplink message via second resources, where a type of message of the second uplink message is based on whether a second timing metric of the UE satisfies the first threshold for the operations according to the first communication mode for the second resources.

In some examples, the threshold indication transmitter 1250 is capable of, configured to, or operable to support a means for outputting, to the UE, an indication of the first threshold associated with the first communication mode and the second threshold associated with the second communication mode.

In some examples, the communication mode operation transmitter 1260 is capable of, configured to, or operable to support a means for outputting, to the UE prior to receiving the first uplink message, an indication of operation in the second communication mode, where the indication of the second communication mode is associated with a cell including the first resources and the second resources, a group of UEs, the UE, or any combination thereof.

In some examples, the indication of operation in the second communication mode is received via one or more messages associated with a continuous-discontinuous reception (C-DRX) configuration, a cell discontinuous transmission (DTX) configuration, a cell DRX configuration, or any combination thereof.

In some examples, the communication mode operation request receiver 1270 is capable of, configured to, or operable to support a means for obtaining, from the UE, a request for operation in the second communication mode.

In some examples, the second communication mode is associated with an inactive duration, an off duration, or both of a cell discontinuous transmission configuration, a cell discontinuous reception configuration, a continuous-discontinuous reception configuration for the UE, or any combination thereof and the first communication mode is associated with an active duration, an on duration, or both of the cell discontinuous transmission configuration, the cell discontinuous reception configuration, the continuous-discontinuous reception configuration for the UE, or any combination thereof.

In some examples, the first uplink message has a cyclic prefix of a first length based on the UE operating within the second communication mode, the first length being different from a second length that is associated with the first communication mode.

In some examples, a first symbol of the first uplink message is repeated as the cyclic prefix of a second symbol of the first uplink message based on the UE operating within the second communication mode.

In some examples, the slot structure reconfiguration transmitter 1265 is capable of, configured to, or operable to support a means for outputting, to the UE, an indication of a reconfiguration of a slot structure for the first resources, the indication including the first length of the cyclic prefix for the first uplink message.

In some examples, the timing metric adjustment transmitter 1255 is capable of, configured to, or operable to support a means for outputting, to the UE and in response to reception of the first uplink message, an indication to adjust a timing of the UE, a frequency of the UE, or both based on the first timing metric of the UE failing to satisfy the first threshold for the operations according to the first communication mode.

In some examples, to support outputting the indication, the timing metric adjustment transmitter 1255 is capable of, configured to, or operable to support a means for outputting, to the UE, a timing adjustment command, a frequency adjustment command, or both.

In some examples, to support outputting the indication, the timing metric adjustment transmitter 1255 is capable of, configured to, or operable to support a means for outputting, to the UE, a DCI message that includes the indication to adjust the timing of the UE, the frequency of the UE, or both and an indication of the second resources for the second uplink message.

In some examples, an offset between the DCI and the second uplink message is based on reception of the indication via the DCI.

In some examples, the type of message of the second uplink message is a first type of message associated with the first communication mode based on the second timing metric of the UE satisfying the first threshold for the operations according to the first communication mode for the second resources or is a second type of message associated a reestablishment of the first communication mode based on the second timing metric of the UE failing to satisfy the first threshold for the operations according to the first communication mode for the second resources.

In some examples, to support obtaining the second uplink message, the uplink message receiver 1245 is capable of, configured to, or operable to support a means for obtaining, from the UE, a request for an uplink timing advance command, a request for a frequency adjustment command, a request for one or more additional instances of a downlink reference signal, or any combination thereof.

In some examples, obtaining the request is via a random access message, a scheduling request message, an uplink control channel message, an uplink data channel message, or any combination thereof.

In some examples, the UE operates within the second communication mode based on a mobility metric of the UE.

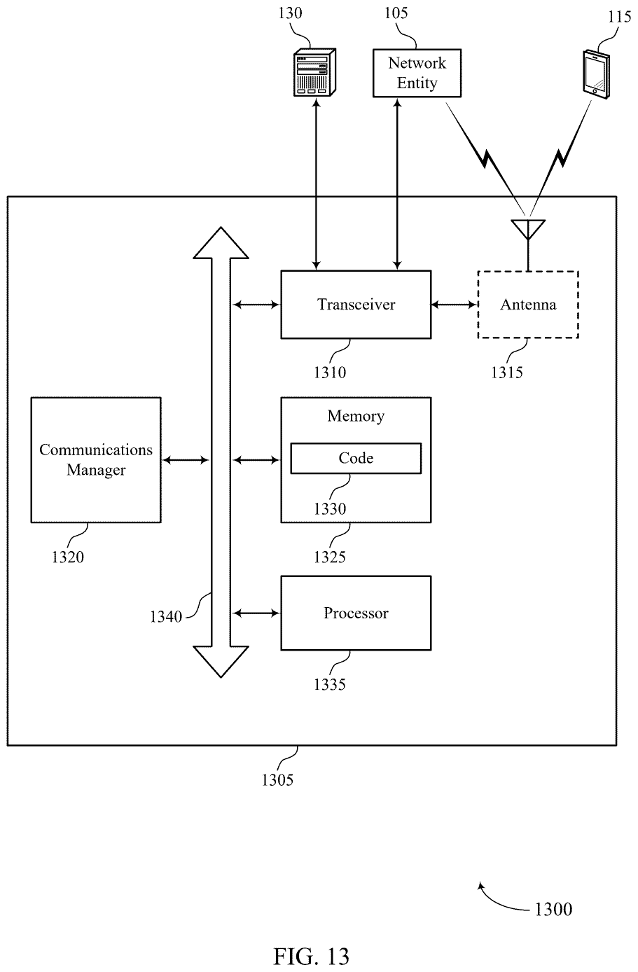

FIG. 13 shows a diagram of a system 1300 including a device 1305 that supports uplink timing and frequency adjustment based on energy saving modes in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting uplink timing and frequency adjustment based on energy saving modes). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for switching from a first communication mode associated with a first set of timing conditions to a second communication mode associated with a second set of timing conditions, the first set of timing conditions including a first transmission periodicity for transmission of a downlink reference signal and the second set of timing conditions including a second transmission periodicity for the transmission of the downlink reference signal, where the second transmission periodicity is different from the first transmission periodicity. The communications manager 1320 is capable of, configured to, or operable to support a means for outputting, to a UE, a control message indicating that the network entity has switched to the second communication mode, the control message including an indication of the second set of timing conditions. The communications manager 1320 is capable of, configured to, or operable to support a means for obtaining, from the UE, a request for one or more additional instances of the downlink reference signal based on a satisfaction of one or more conditions. The communications manager 1320 is capable of, configured to, or operable to support a means for outputting, to the UE, the one or more additional instances of the downlink reference signal based on reception of the request.

Additionally, or alternatively, the communications manager 1320 may support wireless communications in accordance with examples as disclosed herein. For example, the communications manager 1320 is capable of, configured to, or operable to support a means for obtaining, while a UE is operating in a second communication mode, a first uplink message from the UE via first resources of an uplink data channel or an uplink control channel, where, for the first resources, a first timing metric of the UE fails to satisfy a first threshold for operations according to a first communication mode, and where the second communication mode is associated with a second threshold for the first timing metric. The communications manager 1320 is capable of, configured to, or operable to support a means for obtaining, from the UE, a second uplink message via second resources, where a type of message of the second uplink message is based on whether a second timing metric of the UE satisfies the first threshold for the operations according to the first communication mode for the second resources.

By including or configuring the communications manager 1320 in accordance with examples as described herein, the device 1305 may support techniques for utilizing one or more communication modes to support improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of uplink timing and frequency adjustment based on energy saving modes as described herein, or the at least one processor 1335 and the at least one memory 1325 may be otherwise configured to, individually or collectively, perform or support such operations.

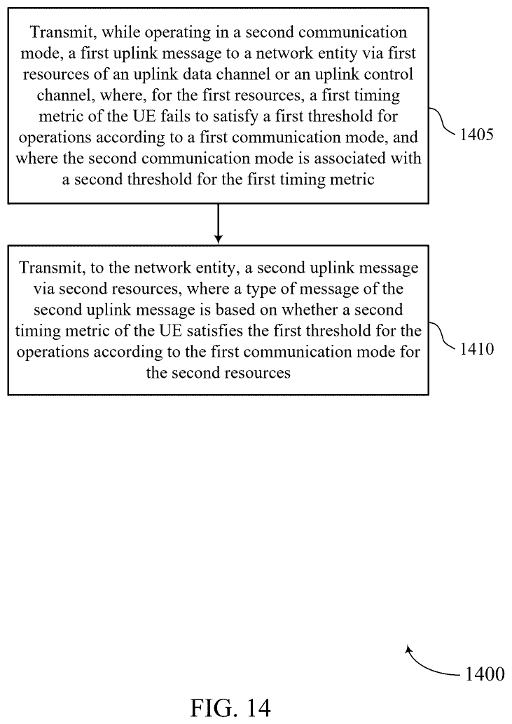

FIG. 14 shows a flowchart illustrating a method 1400 that supports uplink timing and frequency adjustment based on energy saving modes in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, while operating in a second communication mode, a first uplink message to a network entity via first resources of an uplink data channel or an uplink control channel, where, for the first resources, a first timing metric of the UE fails to satisfy a first threshold for operations according to a first communication mode, and where the second communication mode is associated with a second threshold for the first timing metric. The operations of 1405 may be performed in accordance with examples as disclosed herein. In some examples, aspects of the operations of 1405 may be performed by an uplink message transmitter 825 as described with reference to FIG. 8.

At 1410, the method may include transmitting, to the network entity, a second uplink message via second resources, where a type of message of the second uplink message is based on whether a second timing metric of the UE satisfies the first threshold for the operations according to the first communication mode for the second resources. The operations of 1410 may be performed in accordance with examples as disclosed herein. In some examples, aspects of the operations of 1410 may be performed by an uplink message transmitter 825 as described with reference to FIG. 8.

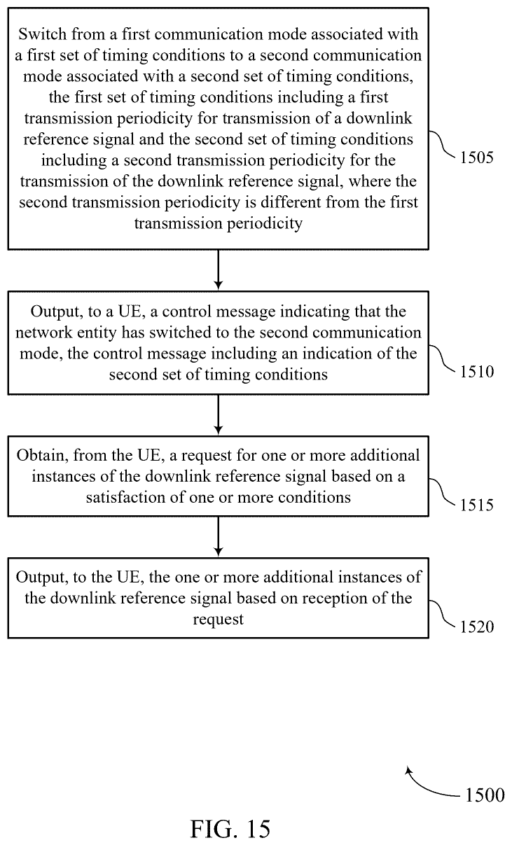

FIG. 15 shows a flowchart illustrating a method 1500 that supports uplink timing and frequency adjustment based on energy saving modes in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include switching from a first communication mode associated with a first set of timing conditions to a second communication mode associated with a second set of timing conditions, the first set of timing conditions including a first transmission periodicity for transmission of a downlink reference signal and the second set of timing conditions including a second transmission periodicity for the transmission of the downlink reference signal, where the second transmission periodicity is different from the first transmission periodicity. The operations of 1505 may be performed in accordance with examples as disclosed herein. In some examples, aspects of the operations of 1505 may be performed by a communication mode switching manager 1225 as described with reference to FIG. 12.

At 1510, the method may include outputting, to a UE, a control message indicating that the network entity has switched to the second communication mode, the control message including an indication of the second set of timing conditions. The operations of 1510 may be performed in accordance with examples as disclosed herein. In some examples, aspects of the operations of 1510 may be performed by a control message transmitter 1230 as described with reference to FIG. 12.

At 1515, the method may include obtaining, from the UE, a request for one or more additional instances of the downlink reference signal based on a satisfaction of one or more conditions. The operations of 1515 may be performed in accordance with examples as disclosed herein. In some examples, aspects of the operations of 1515 may be performed by a downlink reference signal request receiver 1235 as described with reference to FIG. 12.

At 1520, the method may include outputting, to the UE, the one or more additional instances of the downlink reference signal based on reception of the request. The operations of 1520 may be performed in accordance with examples as disclosed herein. In some examples, aspects of the operations of 1520 may be performed by a downlink reference signal transmitter 1240 as described with reference to FIG. 12.

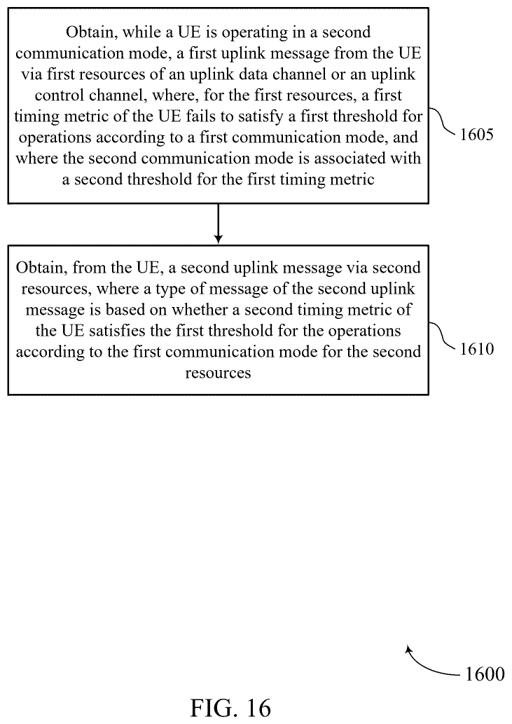

FIG. 16 shows a flowchart illustrating a method 1600 that supports uplink timing and frequency adjustment based on energy saving modes in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include obtaining, while a UE is operating in a second communication mode, a first uplink message from the UE via first resources of an uplink data channel or an uplink control channel, where, for the first resources, a first timing metric of the UE fails to satisfy a first threshold for operations according to a first communication mode, and where the second communication mode is associated with a second threshold for the first timing metric. The operations of 1605 may be performed in accordance with examples as disclosed herein. In some examples, aspects of the operations of 1605 may be performed by an uplink message receiver 1245 as described with reference to FIG. 12.

At 1610, the method may include obtaining, from the UE, a second uplink message via second resources, where a type of message of the second uplink message is based on whether a second timing metric of the UE satisfies the first threshold for the operations according to the first communication mode for the second resources. The operations of 1610 may be performed in accordance with examples as disclosed herein. In some examples, aspects of the operations of 1610 may be performed by an uplink message receiver 1245 as described with reference to FIG. 12.

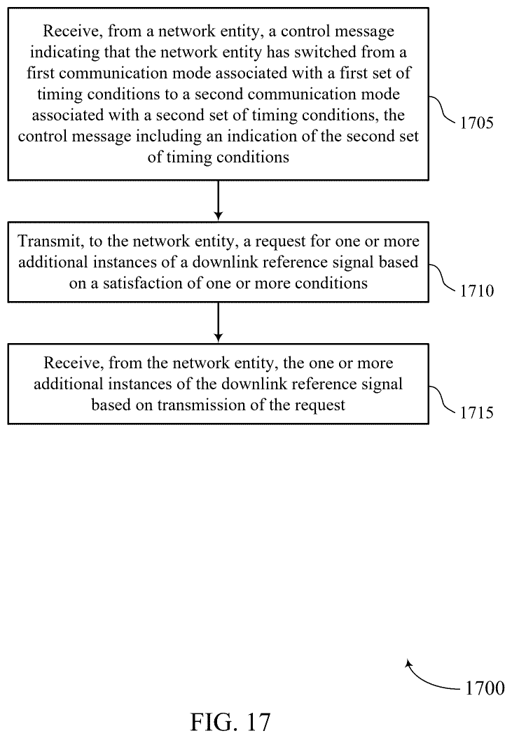

FIG. 17 shows a flowchart illustrating a method 1700 that supports uplink timing and frequency adjustment based on energy saving modes in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, a control message indicating that the network entity has switched from a first communication mode associated with a first set of timing conditions to a second communication mode associated with a second set of timing conditions, the control message including an indication of the second set of timing conditions. The operations of 1705 may be performed in accordance with examples as disclosed herein. In some examples, aspects of the operations of 1705 may be performed by a control message receiver 830 as described with reference to FIG. 8.

At 1710, the method may include transmitting, to the network entity, a request for one or more additional instances of a downlink reference signal based on a satisfaction of one or more conditions. The operations of 1710 may be performed in accordance with examples as disclosed herein. In some examples, aspects of the operations of 1710 may be performed by a downlink reference signal request transmitter 835 as described with reference to FIG. 8.

At 1715, the method may include receiving, from the network entity, the one or more additional instances of the downlink reference signal based on transmission of the request. The operations of 1715 may be performed in accordance with examples as disclosed herein. In some examples, aspects of the operations of 1715 may be performed by a downlink reference signal receiver 840 as described with reference to FIG. 8.

The following provides an overview of aspects of the present disclosure:
Aspect 1: A method for wireless communications by a UE, comprising: transmitting, while operating in a second communication mode, a first uplink message to a network entity via first resources of an uplink data channel or an uplink control channel, wherein, for the first resources, a first timing metric of the UE fails to satisfy a first threshold for operations according to a first communication mode, and wherein the second communication mode is associated with a second threshold for the first timing metric; and transmitting, to the network entity, a second uplink message via second resources, wherein a type of message of the second uplink message is based at least in part on whether a second timing metric of the UE satisfies the first threshold for the operations according to the first communication mode for the second resources.
Aspect 2: The method of aspect 1, further comprising: receiving, from the network entity, an indication of the first threshold associated with the first communication mode and the second threshold associated with the second communication mode.
Aspect 3: The method of any of aspects 1 through 2, further comprising: receiving, prior to transmitting the first uplink message, an indication of operation in the second communication mode, wherein the indication of operation in the second communication mode is associated with a cell comprising the first resources and the second resources, a group of UEs, the UE, or any combination thereof.
Aspect 4: The method of aspect 3, wherein the indication of operation in the second communication mode is received via one or more messages associated with a C-DRX configuration, a cell DTX configuration, a cell DRX configuration, or any combination thereof.
Aspect 5: The method of any of aspects 3 through 4, further comprising: transmitting, to the network entity, a request for operation in the second communication mode.
Aspect 6: The method of any of aspects 1 through 5, wherein the second communication mode is associated with an inactive duration, an off duration, or both of a cell DTX configuration, a cell DRX configuration, a C-DRX configuration for the UE, or any combination thereof and the first communication mode is associated with an active duration, an on duration, or both of the cell DTX configuration, the cell DRX configuration, the C-DRX configuration for the UE, or any combination thereof.
Aspect 7: The method of any of aspects 1 through 6, further comprising: selecting to operate within the second communication mode based at least in part on a duration of a cycle, an inactive period, or both of a DRX configuration, a DTX configuration, or both, wherein transmission of the first uplink message is based at least in part on selecting to operate within the second communication mode.
Aspect 8: The method of any of aspects 1 through 7, wherein the first uplink message has a cyclic prefix of a first length based at least in part on the UE operating within the second communication mode, the first length being different from a second length that is associated with the first communication mode.
Aspect 9: The method of aspect 8, wherein a first symbol of the first uplink message is repeated as the cyclic prefix of a second symbol of the first uplink message based at least in part on the UE operating within the second communication mode.
Aspect 10: The method of any of aspects 8 through 9, further comprising: receiving, from the network entity, an indication of a reconfiguration of a slot structure for the first resources, the indication comprising the first length of the cyclic prefix for the first uplink message.
Aspect 11: The method of any of aspects 1 through 10, further comprising: receiving, from the network entity and in response to the first uplink message, an indication to adjust a timing of the UE, a frequency of the UE, or both based at least in part on the first timing metric of the UE failing to satisfy the first threshold for the operations according to the first communication mode.
Aspect 12: The method of aspect 11, wherein receiving the indication comprises: receiving, from the network entity, a timing adjustment command, a frequency adjustment command, or both.
Aspect 13: The method of any of aspects 11 through 12, wherein receiving the indication comprises: receiving, from the network entity, a DCI message that comprises the indication to adjust the timing of the UE, the frequency of the UE, or both and an indication of the second resources for the second uplink message.
Aspect 14: The method of aspect 13, wherein an offset between the DCI and the second uplink message is based at least in part on reception of the indication via the DCI.
Aspect 15: The method of any of aspects 1 through 14, wherein the type of message of the second uplink message is a first type of message associated with the first communication mode based at least in part on the second timing metric of the UE satisfying the first threshold for the operations according to the first communication mode for the second resources or is a second type of message associated a reestablishment of the first communication mode based at least in part on the second timing metric of the UE failing to satisfy the first threshold for the operations according to the first communication mode for the second resources.
Aspect 16: The method of any of aspects 1 through 15, further comprising: determining that the second timing metric of the UE satisfies the first threshold for the operations according to the first communication mode for the second resources based at least in part on an absence of an indication for adjustment of the first timing metric, wherein the second uplink message is associated with a first type of message based at least in part on the determination.
Aspect 17: The method of any of aspects 1 through 16, wherein transmitting the second uplink message comprises: transmitting, to the network entity, a request for an uplink TAC, a request for a frequency adjustment command, a request for one or more additional instances of a downlink reference signal, or any combination thereof.
Aspect 18: The method of aspect 17, wherein transmission of the request is via a random access message, a scheduling request message, an uplink control channel message, an uplink data channel message, or any combination thereof.
Aspect 19: The method of any of aspects 1 through 18, further comprising: adjusting a duration of an uplink synchronization timer based at least in part on the UE operating within the second communication mode.
Aspect 20: The method of any of aspects 1 through 19, further comprising: performing one or more timing metric adjustments based at least in part on the first timing metric of the UE failing to satisfy the first threshold for the operations according to the first communication mode, wherein the one or more timing metric adjustments are performed based at least in part on the first timing metric being within a respective range, the one or more timing metric adjustments are performed based at least in part on a respective duration from expiration of a timer associated with the first communication mode, or both.
Aspect 21: The method of aspect 20, wherein the first uplink message, the second uplink message, or both include a request for an uplink TAC based at least in part on the first timing metric being outside of the respective range, an expiration of the respective duration, or both.
Aspect 22: The method of any of aspects 1 through 21, wherein the UE operates within the second communication mode based at least in part on a mobility metric of the UE.
Aspect 23: A method for wireless communications by a network entity, comprising: switching from a first communication mode associated with a first set of timing conditions to a second communication mode associated with a second set of timing conditions, the first set of timing conditions comprising a first transmission periodicity for transmission of a downlink reference signal and the second set of timing conditions comprising a second transmission periodicity for the transmission of the downlink reference signal, wherein the second transmission periodicity is different from the first transmission periodicity; outputting, to a UE, a control message indicating that the network entity has switched to the second communication mode, the control message comprising an indication of the second set of timing conditions; obtaining, from the UE, a request for one or more additional instances of the downlink reference signal based at least in part on a satisfaction of one or more conditions; and outputting, to the UE, the one or more additional instances of the downlink reference signal based at least in part on reception of the request.
Aspect 24: The method of aspect 23, wherein the one or more conditions comprise a threshold time condition, a traffic priority condition, a level of mobility condition, a location condition, a beam change condition, a timing metric condition, or any combination thereof.
Aspect 25: The method of aspect 24, wherein satisfaction of the threshold time condition is based at least in part on a time since a transmission of an adjustment command satisfying the threshold time condition.
Aspect 26: The method of any of aspects 24 through 25, wherein satisfaction of the traffic priority condition is based at least in part on scheduling the UE with uplink traffic associated with a priority level that satisfies a traffic priority threshold.
Aspect 27: The method of any of aspects 24 through 26, wherein satisfaction of the level of mobility condition is based at least in part on a level of mobility of the UE satisfying a threshold level of mobility.
Aspect 28: The method of any of aspects 24 through 27, wherein satisfaction of the location condition is based at least in part on the UE moving a threshold distance away from the network entity.
Aspect 29: The method of any of aspects 24 through 28, wherein satisfaction of the beam change condition is based at least in part on a change of a beam used by the UE.
Aspect 30: The method of any of aspects 24 through 29, wherein satisfaction of the timing metric condition is based at least in part on the UE failing to satisfy a threshold for operations according to the first communication mode.
Aspect 31: The method of any of aspects 24 through 30, wherein the timing metric condition is associated with a respective carrier frequency of the network entity, a cell associated with the downlink reference signal, a beam associated with the downlink reference signal, or a combination thereof.
Aspect 32: A method for wireless communications by a network entity, comprising: obtaining, while a UE is operating in a second communication mode, a first uplink message from the UE via first resources of an uplink data channel or an uplink control channel, wherein, for the first resources, a first timing metric of the UE fails to satisfy a first threshold for operations according to a first communication mode, and wherein the second communication mode is associated with a second threshold for the first timing metric; and obtaining, from the UE, a second uplink message via second resources, wherein a type of message of the second uplink message is based at least in part on whether a second timing metric of the UE satisfies the first threshold for the operations according to the first communication mode for the second resources.
Aspect 33: The method of aspect 32, further comprising: outputting, to the UE, an indication of the first threshold associated with the first communication mode and the second threshold associated with the second communication mode.
Aspect 34: The method of aspect 33, further comprising: outputting, to the UE prior to receiving the first uplink message, an indication of operation in the second communication mode, wherein the indication of the second communication mode is associated with a cell comprising the first resources and the second resources, a group of UEs, the UE, or any combination thereof.
Aspect 35: The method of aspect 34, wherein the indication of operation in the second communication mode is received via one or more messages associated with a C-DRX configuration, a cell DTX configuration, a cell DRX configuration, or any combination thereof.
Aspect 36: The method of any of aspects 34 through 35, further comprising: obtaining, from the UE, a request for operation in the second communication mode.
Aspect 37: The method of any of aspects 32 through 36, wherein the second communication mode is associated with an inactive duration, an off duration, or both of a cell DTX configuration, a cell DRX configuration, a C-DRX configuration for the UE, or any combination thereof and the first communication mode is associated with an active duration, an on duration, or both of the cell DTX configuration, the cell DRX configuration, the C-DRX configuration for the UE, or any combination thereof.
Aspect 38: The method of any of aspects 32 through 37, wherein the first uplink message has a cyclic prefix of a first length based at least in part on the UE operating within the second communication mode, the first length being different from a second length that is associated with the first communication mode.
Aspect 39: The method of aspect 38, wherein a first symbol of the first uplink message is repeated as the cyclic prefix of a second symbol of the first uplink message based at least in part on the UE operating within the second communication mode.
Aspect 40: The method of any of aspects 38 through 39, further comprising: outputting, to the UE, an indication of a reconfiguration of a slot structure for the first resources, the indication comprising the first length of the cyclic prefix for the first uplink message.
Aspect 41: The method of any of aspects 32 through 40, further comprising: outputting, to the UE and in response to reception of the first uplink message, an indication to adjust a timing of the UE, a frequency of the UE, or both based at least in part on the first timing metric of the UE failing to satisfy the first threshold for the operations according to the first communication mode.
Aspect 42: The method of aspect 41, wherein outputting the indication comprises: outputting, to the UE, a timing adjustment command, a frequency adjustment command, or both.
Aspect 43: The method of any of aspects 41 through 42, wherein outputting the indication comprises: outputting, to the UE, a DCI message that comprises the indication to adjust the timing of the UE, the frequency of the UE, or both and an indication of the second resources for the second uplink message.
Aspect 44: The method of aspect 43, wherein an offset between the DCI and the second uplink message is based at least in part on reception of the indication via the DCI.
Aspect 45: The method of any of aspects 32 through 44, wherein the type of message of the second uplink message is a first type of message associated with the first communication mode based at least in part on the second timing metric of the UE satisfying the first threshold for the operations according to the first communication mode for the second resources or is a second type of message associated a reestablishment of the first communication mode based at least in part on the second timing metric of the UE failing to satisfy the first threshold for the operations according to the first communication mode for the second resources.
Aspect 46: The method of any of aspects 32 through 45, wherein obtaining the second uplink message comprises: obtaining, from the UE, a request for an uplink TAC, a request for a frequency adjustment command, a request for one or more additional instances of a downlink reference signal, or any combination thereof.
Aspect 47: The method of aspect 46, wherein obtaining the request is via a random access message, a scheduling request message, an uplink control channel message, an uplink data channel message, or any combination thereof.
Aspect 48: The method of any of aspects 32 through 47, wherein the UE operates within the second communication mode based at least in part on a mobility metric of the UE.
Aspect 49: A method for wireless communications by a UE, comprising: receiving, from a network entity, a control message indicating that the network entity has switched from a first communication mode associated with a first set of timing conditions to a second communication mode associated with a second set of timing conditions, the control message comprising an indication of the second set of timing conditions; transmitting, to the network entity, a request for one or more additional instances of a downlink reference signal based at least in part on a satisfaction of one or more conditions; and receiving, from the network entity, the one or more additional instances of the downlink reference signal based at least in part on transmission of the request.
Aspect 50: The method of aspect 49, wherein the one or more conditions comprise a threshold time condition, a traffic priority condition, a level of mobility condition, a location condition, a beam change condition, a timing metric condition, or any combination thereof.
Aspect 51: The method of aspect 50, wherein satisfaction of the threshold time condition is based at least in part on a time since a reception of an adjustment command satisfying the threshold time condition.
Aspect 52: The method of any of aspects 50 through 51, wherein satisfaction of the traffic priority condition is based at least in part on being scheduled with uplink traffic associated with a priority level that satisfies a traffic priority threshold.
Aspect 53: The method of any of aspects 50 through 52, wherein satisfaction of the level of mobility condition is based at least in part on a level of mobility of the UE satisfying a threshold level of mobility.
Aspect 54: The method of any of aspects 50 through 53, wherein satisfaction of the location condition is based at least in part on the UE moving a threshold distance away from the network entity.
Aspect 55: The method of any of aspects 50 through 54, wherein satisfaction of the beam change condition is based at least in part on a change of a beam used by the UE.
Aspect 56: The method of any of aspects 50 through 55, wherein satisfaction of the timing metric condition is based at least in part on the UE failing to satisfy a threshold for operations according to the second communication mode.
Aspect 57: The method of aspect 56, wherein the timing metric condition is associated with a respective carrier frequency of the network entity, a respective downlink signal, or both.
Aspect 58: A UE for wireless communications, comprising one or more memories storing processor-executable code, and one or more processors coupled with the one or more memories and individually or collectively operable to execute the code to cause the UE to perform a method of any of aspects 1 through 22.
Aspect 59: A UE for wireless communications, comprising at least one means for performing a method of any of aspects 1 through 22.
Aspect 60: A non-transitory computer-readable medium storing code for wireless communications, the code comprising instructions executable by one or more processors to perform a method of any of aspects 1 through 22.
Aspect 61: A network entity for wireless communications, comprising one or more memories storing processor-executable code, and one or more processors coupled with the one or more memories and individually or collectively operable to execute the code to cause the network entity to perform a method of any of aspects 23 through 31.
Aspect 62: A network entity for wireless communications, comprising at least one means for performing a method of any of aspects 23 through 31.
Aspect 63: A non-transitory computer-readable medium storing code for wireless communications, the code comprising instructions executable by one or more processors to perform a method of any of aspects 23 through 31.
Aspect 64: A network entity for wireless communications, comprising one or more memories storing processor-executable code, and one or more processors coupled with the one or more memories and individually or collectively operable to execute the code to cause the network entity to perform a method of any of aspects 32 through 48.
Aspect 65: A network entity for wireless communications, comprising at least one means for performing a method of any of aspects 32 through 48.
Aspect 66: A non-transitory computer-readable medium storing code for wireless communications, the code comprising instructions executable by one or more processors to perform a method of any of aspects 32 through 48.
Aspect 67: A UE for wireless communications, comprising one or more memories storing processor-executable code, and one or more processors coupled with the one or more memories and individually or collectively operable to execute the code to cause the UE to perform a method of any of aspects 49 through 57.
Aspect 68: A UE for wireless communications, comprising at least one means for performing a method of any of aspects 49 through 57.
Aspect 69: A non-transitory computer-readable medium storing code for wireless communications, the code comprising instructions executable by one or more processors to perform a method of any of aspects 49 through 57.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, while operating in a second communication mode, a first uplink message to a network entity via first resources of an uplink data channel or an uplink control channel, wherein, for the first resources, a first timing metric of the UE fails to satisfy a first threshold for operations according to a first communication mode, and wherein the second communication mode is associated with a second threshold for the first timing metric; and
transmit, to the network entity, a second uplink message via second resources, wherein a type of message of the second uplink message is based at least in part on whether a second timing metric of the UE satisfies the first threshold for the operations according to the first communication mode for the second resources.

2. The UE of claim 1, wherein the one or more processors are individually or collectively further operable to execute the code to cause the UE to:
receive, from the network entity, an indication of the first threshold associated with the first communication mode and the second threshold associated with the second communication mode.

3. The UE of claim 1, wherein the one or more processors are individually or collectively further operable to execute the code to cause the UE to:
receive, prior to transmitting the first uplink message, an indication of operation in the second communication mode, wherein the indication of operation in the second communication mode is associated with a cell comprising the first resources and the second resources, a group of UEs, the UE, or any combination thereof.

4. The UE of claim 1, wherein the second communication mode is associated with an inactive duration, an off duration, or both of a cell discontinuous transmission configuration, a cell discontinuous reception configuration, a continuous-discontinuous reception configuration for the UE, or any combination thereof and the first communication mode is associated with an active duration, an on duration, or both of the cell discontinuous transmission configuration, the cell discontinuous reception configuration, the continuous-discontinuous reception configuration for the UE, or any combination thereof.

5. The UE of claim 1, wherein the one or more processors are individually or collectively further operable to execute the code to cause the UE to:
select to operate within the second communication mode based at least in part on a duration of a cycle, an inactive period, or both of a discontinuous reception configuration, a discontinuous transmission configuration, or both, wherein transmission of the first uplink message is based at least in part on selecting to operate within the second communication mode.

6. The UE of claim 1, wherein the first uplink message has a cyclic prefix of a first length based at least in part on the UE operating within the second communication mode, the first length being different from a second length that is associated with the first communication mode.

7. The UE of claim 1, wherein the one or more processors are individually or collectively further operable to execute the code to cause the UE to:
receive, from the network entity and in response to the first uplink message, an indication to adjust a timing of the UE, a frequency of the UE, or both based at least in part on the first timing metric of the UE failing to satisfy the first threshold for the operations according to the first communication mode.

8. The UE of claim 1, wherein the type of message of the second uplink message is a first type of message associated with the first communication mode based at least in part on the second timing metric of the UE satisfying the first threshold for the operations according to the first communication mode for the second resources or is a second type of message associated a reestablishment of the first communication mode based at least in part on the second timing metric of the UE failing to satisfy the first threshold for the operations according to the first communication mode for the second resources.

9. The UE of claim 1, wherein the one or more processors are individually or collectively further operable to execute the code to cause the UE to:
determine that the second timing metric of the UE satisfies the first threshold for the operations according to the first communication mode for the second resources based at least in part on an absence of an indication for adjustment of the first timing metric, wherein the second uplink message is associated with a first type of message based at least in part on the determination.

10. The UE of claim 1, wherein, to transmit the second uplink message, the one or more processors are individually or collectively operable to execute the code to cause the UE to:
transmit, to the network entity, a request for an uplink timing advance command, a request for a frequency adjustment command, a request for one or more additional instances of a downlink reference signal, or any combination thereof.

11. The UE of claim 1, wherein the one or more processors are individually or collectively further operable to execute the code to cause the UE to:
adjust a duration of an uplink synchronization timer based at least in part on the UE operating within the second communication mode.

12. The UE of claim 1, wherein the one or more processors are individually or collectively further operable to execute the code to cause the UE to:
perform one or more timing metric adjustments based at least in part on the first timing metric of the UE failing to satisfy the first threshold for the operations according to the first communication mode, wherein the one or more timing metric adjustments are performed based at least in part on the first timing metric being within a respective range, the one or more timing metric adjustments are performed based at least in part on a respective duration from expiration of a timer associated with the first communication mode, or both.

13. A network entity, comprising:
one or more memories storing processor-executable code; and
one or more processors coupled with the one or more memories and individually or collectively operable to execute the code to cause the network entity to:
switch from a first communication mode associated with a first set of timing conditions to a second communication mode associated with a second set of timing conditions, the first set of timing conditions comprising a first transmission periodicity for transmission of a downlink reference signal and the second set of timing conditions comprising a second transmission periodicity for the transmission of the downlink reference signal, wherein the second transmission periodicity is different from the first transmission periodicity;
output, to a user equipment (UE), a control message indicating that the network entity has switched to the second communication mode, the control message comprising an indication of the second set of timing conditions;
obtain, from the UE, a request for one or more additional instances of the downlink reference signal based at least in part on a satisfaction of one or more conditions; and
output, to the UE, the one or more additional instances of the downlink reference signal based at least in part on reception of the request.

14. The network entity of claim 13, wherein the one or more conditions comprise a threshold time condition, a traffic priority condition, a level of mobility condition, a location condition, a beam change condition, a timing metric condition, or any combination thereof.

15. A network entity, comprising:
one or more memories storing processor-executable code; and
one or more processors coupled with the one or more memories and individually or collectively operable to execute the code to cause the network entity to:
obtain, while a user equipment (UE) is operating in a second communication mode, a first uplink message from the UE via first resources of an uplink data channel or an uplink control channel, wherein, for the first resources, a first timing metric of the UE fails to satisfy a first threshold for operations according to a first communication mode, and wherein the second communication mode is associated with a second threshold for the first timing metric; and
obtain, from the UE, a second uplink message via second resources, wherein a type of message of the second uplink message is based at least in part on whether a second timing metric of the UE satisfies the first threshold for the operations according to the first communication mode for the second resources.

16. The network entity of claim 15, wherein the one or more processors are individually or collectively further operable to execute the code to cause the network entity to:
output, to the UE, an indication of the first threshold associated with the first communication mode and the second threshold associated with the second communication mode.

17. The network entity of claim 15, wherein the second communication mode is associated with an inactive duration, an off duration, or both of a cell discontinuous transmission configuration, a cell discontinuous reception configuration, a continuous-discontinuous reception configuration for the UE, or any combination thereof and the first communication mode is associated with an active duration, an on duration, or both of the cell discontinuous transmission configuration, the cell discontinuous reception configuration, the continuous-discontinuous reception configuration for the UE, or any combination thereof.

18. The network entity of claim 15, wherein the one or more processors are individually or collectively further operable to execute the code to cause the network entity to:
output, to the UE and in response to reception of the first uplink message, an indication to adjust a timing of the UE, a frequency of the UE, or both based at least in part on the first timing metric of the UE failing to satisfy the first threshold for the operations according to the first communication mode.

19. The network entity of claim 15, wherein the type of message of the second uplink message is a first type of message associated with the first communication mode based at least in part on the second timing metric of the UE satisfying the first threshold for the operations according to the first communication mode for the second resources or is a second type of message associated a reestablishment of the first communication mode based at least in part on the second timing metric of the UE failing to satisfy the first threshold for the operations according to the first communication mode for the second resources.

20. The network entity of claim 15, wherein, to obtain the second uplink message, the one or more processors are individually or collectively operable to execute the code to cause the network entity to:
obtain, from the UE, a request for an uplink timing advance command, a request for a frequency adjustment command, a request for one or more additional instances of a downlink reference signal, or any combination thereof.
